(19) United States
(12) Patent Application Publication
(10) Pub. No.: US 2009/0157458 A1
(43) Pub. Date: Jun. 18, 2009

(54) SUPPLY CHAIN EVALUATION SYSTEM, METHOD, AND PROGRAM

(75) Inventors: Manabu Naganuma, Yokohama (JP); Toshiyuki Sakuma, Kawasaki (JP); Ken Igarashi, Miura (JP); Naoyuki Katsube, Yokohama (JP)

Correspondence Address: BRUNDIDGE & STANGER, P.C., 1700 DIAGONAL ROAD, SUITE 330, ALEXANDRIA, VA, 22314, US

(73) Assignee: Hitachi, Ltd.

(21) Appl. No.: 12/329,255

(22) Filed: Dec. 5, 2008

(30) Foreign Application Priority Data
Dec. 7, 2007 (JP) 2007-317486

(51) Int. Cl. G06Q 10/00

(52) U.S. Cl. 705/7; 705/28

(57) ABSTRACT

Provided is a supply chain evaluation system, in which supply chain planning is formulated according to a simulation time control, and a flow of physical distribution from procurement via production and shipment through a client is simulated based on the supply chain planning, which are repeated during a simulation time. In the supply chain evaluation system, after the supply chain planning and after a physical distribution calculation processing, an inventory volume is calculated for each problem, and presented along with inventory transition. Accordingly, it is possible to obtain effects of SCM measures through a simulation not only in a form of an inventory waveform but also by outputting an inventory volume after calculating the inventory volume for each inventory occurrence factor (problem structure).

### BACKGROUND OF THE INVENTION

The present invention relates to a supply chain evaluation technique for performing a quantitative evaluation on a supply chain corresponding to business activities for supplying goods to customers under the influence of: a change in physical distribution due to centralization or decentralization of shops; how to formulate supply chain planning; or a change in method of controlling an inventory position, a safety inventory level, or the like.

Businesses for supplying goods to customers are continuously working toward implementation of measures such as reduction in physical distribution lead time and shortening in cycle of production planning, that is, so-called supply chain management reform (hereinafter, referred to as “SCM reform”), with the aim of reducing an excess inventory or a sales opportunity loss.

The SCM reform involves large-scale investments in centralization/decentralization of sites, change of a business process, introduction of a new information system. Therefore, in order to speedily implement the measures ensuring greater effects as intended, it is essential to perform trial calculations of the effects before taking the measures.

Against such a backdrop, there is conventionally devised a method of previously evaluating a plan for measures of the SCM reform by using a simulation to thereby reduce a risk of failure in the reform.

For example, Japanese Patent Laid-open Publication No. 2000-132619 discloses an SCM evaluation method in which the measures of the SCM reform in terms of a forecasted demand quantity, an order quantity, a lead time of each of processes constituting a supply chain, a point at which an inventory is retained, and the like are input to calculate an index value such as an inventory waveform of each process. Meanwhile, Japanese Patent Laid-open Publication No. 2004-118321 discloses a method of using a simulation to calculate costs in units of process activities such as order taking, warehousing, inventory stock, and inventory taking in order to grasp costs required for physical distribution.

[Patent document 1] Japanese Patent Laid-open Publication No. 2000-132619
[Patent document 2] Japanese Patent Laid-open Publication No. 2004-118321

However, those techniques are directed to an evaluation of a process in terms of an inventory volume, costs, warehousing/delivery, and expense-item-specific costs, thus, they are insufficient to calculate accurately a volume regarding an excess/insufficient inventory. To be described in detail, up to now, inventory problems have been considered to be solved by analyzing effects produced by reduction measures (for example, review of a safety inventory value). Such effects could be obtained in a visualized manner, e.g., waveform, by comparing current situations and results from the reform. However, only by using such a waveform, it is difficult to perform a sufficient evaluation of inventory optimization for an evaluation of measures (for example, method of setting a safety inventory every product life cycle) regarding the inventory optimization to be a future object. In addition, there is a problem that the inventory problems are hard to be recognized by comparison between waveforms before and after a change in each measure or by a process-basis cost evaluation.

### SUMMARY OF THE INVENTION

The present invention has been made in order to solve the above-mentioned problem, and an object thereof is to provide a technique for obtaining effects of SCM measures through a simulation not only in a form of an inventory waveform but also by outputting an inventory volume after calculating the inventory volume for each inventory occurrence factor (problem structure).

In order to solve the above-mentioned problem, the present invention discloses a supply chain evaluation system. According to the supply chain evaluation system, supply chain planning is formulated according to a simulation time control, and a flow of physical distribution from procurement via production and shipment through a client is simulated based on the supply chain planning, which are repeated during a simulation time. Further, in the supply chain evaluation system, after the supply chain planning and a physical distribution calculation processing are completed, an inventory volume is calculated for each problem, and a result of the calculation is presented along with inventory transition. This makes it possible to speedily identify an excess/insufficient inventory and its cause.

For example, the present invention provides a supply chain evaluation system being excutable on a computer system, in which, based on data obtained by modeling a supply chain corresponding to business activities for supplying goods to customers on a computer, a simulation is performed to evaluate reform effects when a supply chain model thus obtained is changed,

wherein:

the computer system is configured to:

perform a processing of alternately repeating a supply chain planning calculation and a physical distribution calculation;

perform a processing of calculating an inventory volume after each calculation processing for each inventory occurrence factor; and

perform a processing of outputting the inventory volume for each inventory occurrence factor.

According to the present invention, it is possible to obtain effects of SCM measures through a simulation not only in a form of a mere inventory waveform but also by outputting an inventory volume after calculating the inventory volume for each inventory occurrence factor (problem structure).

For example, according to an embodiment of the present invention, not only an elapsed-time-basis inventory constituting a simulation result is shown merely with transitions, but also an increase/decrease in inventory occurring in the course of a physical distribution processing is presented separately with respect to each problem being occurred, and is further presented in detail in form of an inventory in an active status based on planning reservation situations after the supply chain planning. This makes it possible to perform not only the conventional evaluation of inventory reduction effects in comparison between plans but also an evaluation with regard to whether or not the inventory is adequately controlled by chronologically checking a significance of an inventory problem for each plan is realized. Thus, the prevention of repeated reevaluations and speedy and reliable implementation of the measures could be achieved, that results in earlier recovery on investment and suppression of unnecessary investment costs.

### BRIEF DESCRIPTION OF THE DRAWINGS

In the accompanying drawings:

FIG. 1 is a diagram illustrating an image of a supply chain model according to an embodiment of the present invention;

FIG. 2A is a diagram illustrating a hardware configuration of a supply chain evaluation system according to the embodiment of the present invention;

FIG. 2B is a functional block diagram of the supply chain evaluation system according to the embodiment of the present invention;

FIG. 3 is a flowchart illustrating a flow of an operation of the supply chain evaluation system;

FIG. 4 is a diagram illustrating input information;

FIG. 5A is a table illustrating a configuration example of planning reference date information;

FIG. 5B is a table illustrating a configuration example of parts table information;

FIG. 5C is a table illustrating a configuration example of shop information;

FIG. 6A is a table illustrating a configuration example of transportation information;

FIG. 6B is a table illustrating a configuration example of shop processing information;

FIG. 6C is a table illustrating a configuration example of safety inventory information;

FIG. 7A is a table illustrating a configuration example of demand planning information;

FIG. 7B is a table illustrating a configuration example of actual demand information;

FIG. 8A is a table illustrating a configuration example of initial inventory information;

FIG. 8B is a table illustrating a configuration example of initial in-process information;

FIG. 8C is a table illustrating a configuration example of initial warehousing schedule information;

FIG. 8D is a table illustrating a configuration example of order-allocated inventory reservation point information;

FIG. 9 is a table illustrating a configuration example of physical distribution constraint information;

FIG. 10 is a flowchart of a planning reference date control processing;

FIG. 11 is a flowchart of a supply chain planning calculation processing;

FIG. 12A is a table illustrating a configuration example of a required quantity expansion result of an MRP calculation which is calculated in a supply chain planning calculation;

FIG. 12B is a table illustrating a configuration example of an inventory information result of the MRP calculation;

FIG. 13 is a flowchart of a problem-specific inventory calculation processing after SCM planning;

FIG. 14 is a flowchart of an excess or insufficient inventory calculation processing (S1301);

FIG. 15A is a flowchart of a problem-specific inventory volume calculation processing after the planning (S1302);

FIG. 15B is a diagram illustrating an example image of the problem-specific inventory volume calculation processing;

FIG. 16 is a flowchart of a physical distribution calculation processing (S106);

FIG. 17A is a first half of a flowchart of a physical distribution change calculation processing (S1602);

FIG. 17B is a second half of the flowchart of the physical distribution change calculation processing (S1602) (continued from FIG. 17A);

FIG. 17C is a flowchart of a physical distribution payout calculation processing (S1604);

FIG. 17D is a diagram illustrating an image of a warehouse quantity calculation processing (S1731);

FIG. 17E is a diagram illustrating an image of an inventory deduction calculation processing (S1732);

FIG. 17F is a diagram illustrating an image of an in-process quantity calculation processing (S1733);

FIG. 17G is a diagram illustrating an image of a delivery quantity calculation processing (S1734);

FIG. 17H is a diagram illustrating an image of an out-of-stock quantity calculation processing (S1735);

FIG. 17I is a diagram illustrating probability random number models of Step S1704;

FIG. 17J is a diagram illustrating an example of calculating the probability random number model in Step S1704;

FIG. 18A is a table of a configuration example of a physical distribution required quantity result obtained by a physical distribution calculation;

FIG. 18B is a table of a configuration example of a physical distribution payout result obtained by the physical distribution calculation;

FIG. 19 is a flowchart of a problem-specific inventory calculation processing after the physical distribution calculation (S107);

FIG. 20 is a flowchart of a defective inventory calculation processing (S1901) of the problem-specific inventory calculation processing after the physical distribution calculation;

FIG. 21 is a flowchart of an early/late lead time inventory calculation processing (S1902) of the problem-specific inventory calculation processing after the physical distribution calculation;

FIG. 22 is a flowchart of a production dispersion inventory calculation processing (S1903) of the problem-specific inventory calculation processing after the physical distribution calculation;

FIG. 23 is a diagram illustrating output information of the supply chain evaluation system;

FIG. 24A is a table illustrating a configuration example of PI transition information;

FIG. 24B is a table illustrating a configuration example of KPI information;

FIG. 24C is a table illustrating a configuration example of problem-specific inventory information after the SCM planning;

FIG. 25 is a table illustrating a configuration example of problem-specific inventory information after the physical distribution calculation;

FIG. 26 is a diagram illustrating an output graph image;

FIG. 27 is a diagram illustrating a graph image of a problem-specific inventory after the supply chain planning;

FIG. 28 is a diagram illustrating a graph image of a problem-specific inventory after the physical distribution calculation; and

FIG. 29 is a diagram illustrating a graph image of a problem-specific inventory.

### DESCRIPTION OF THE PREFERRED EMBODIMENT

Hereinafter, description is made of a supply chain evaluation system according to an embodiment of the present invention.

<Model to which this Embodiment is Applied>

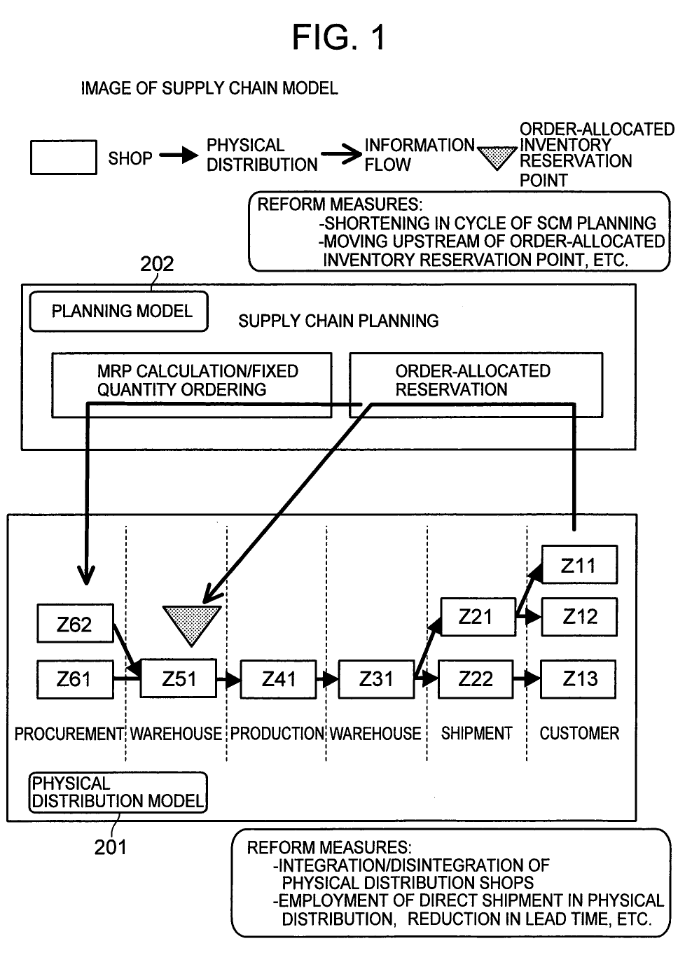

First, FIG. 1 is used to illustrate an image of a supply chain model handled by the supply chain evaluation system. Illustrated in the lower half of FIG. 1 is an example of a physical distribution model 201 that forms an image of an entire supply chain. In the physical distribution model, goods are flowed from procurement shops Z61 and Z62 through a warehouse shop Z51, a production shop Z41, a warehouse shop Z31, and shipment shops Z21 and Z22 to customers Z11, Z12, and Z13 that are final destinations of goods supply. Illustrated in the upper half of FIG. 1 is an image of a planning model 202 for formulating supply chain planning including order-allocated reservation and production planning for the physical distribution model. In those planning model 202 and physical distribution model 201, supply chain management reform (SCM reform) involves scenes for trial calculations of effects of such measures as to integrate physical distribution shops, attempt to reduce a lead time by employing direct shipment, shorten a cycle of plan formulation in the supply chain planning, and perform production by moving a reservation point allocated to an order from a product inventory to a parts inventory. In those scenes, the supply chain evaluation system is used to perform the trial calculations for inventory reduction effects, out-of-stock reduction effects, and the like.

<Hardware Configuration Example>

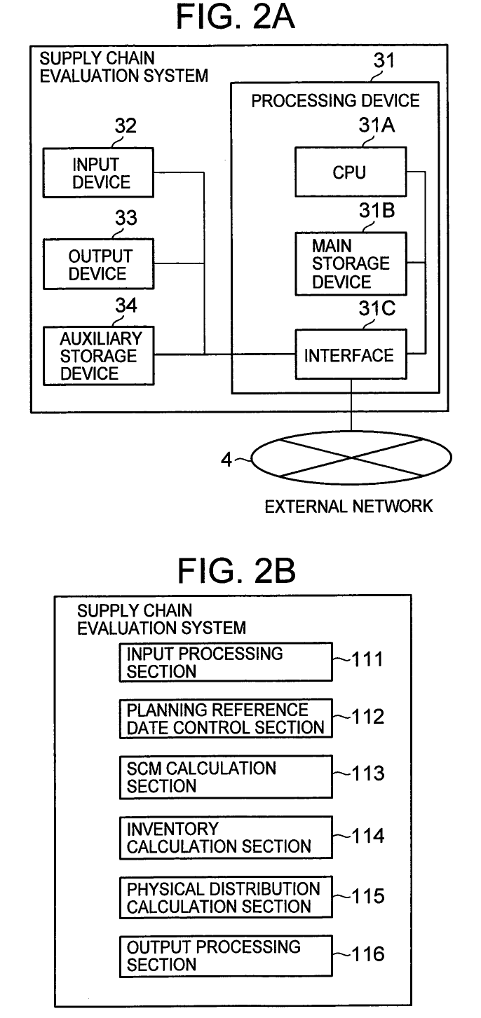

FIG. 2A is used to describe a hardware configuration for executing the supply chain evaluation system. The supply chain evaluation system is executed by a computer system including a processing device 31 for executing a program, an input device 32 including a keyboard and a mouse, an output device 33 including a display and a printer, and an auxiliary storage device 34 including hardware and a memory storage medium. The processing device 31 includes a central processing unit (CPU) 31A, a main storage device 31B, and an interface 31C, and it could be connected to an external network 4.

<Functional Configuration Example>

FIG. 2B is a functional block diagram of the supply chain evaluation system. The supply chain evaluation system includes an input processing section 111 for receiving contents input by an operator, a planning reference date control section 112 for a control of a planning reference date in a simulation calculation described later, an SCM calculation section 113 for a supply chain planning calculation, an inventory calculation section 114 for obtaining a problem-specific inventory volume regarding an inventory obtained by a physical distribution calculation and results of the SCM planning calculation, a physical distribution calculation section 115 for the physical distribution calculation, and an output processing section 116 for displaying a simulation result onto the output device 33. It should be noted that each functional section is achieved by the CPU 31A executing a predetermined program loaded into the memory (main storage device) 31B. Therefore, the main storage device 31B or the auxiliary storage device 34 previously stores a program for executing a processing of each functional section. The program may be loaded onto the main storage device 31B via the external network 4. Alternatively, the program may be recorded on a portable recording medium.

<Description of Operation>

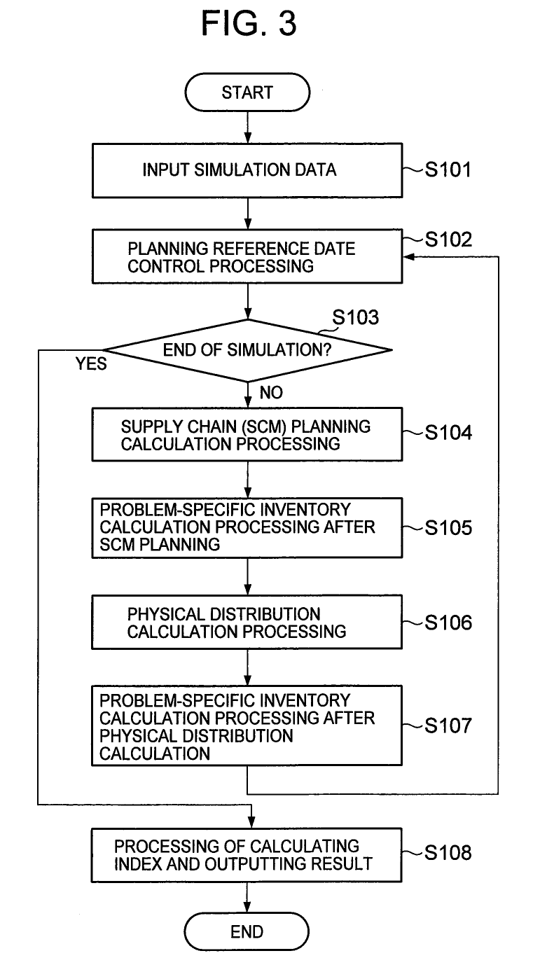

FIG. 3 illustrates a main flowchart of an operation of the supply chain evaluation system. First, an outline thereof is described.

After a startup of the supply chain evaluation system, in response to an instruction from the operator, the input processing section 111 executes a simulation data inputting processing (S101). Then, the planning reference date control section 112 executes a planning reference date control processing (S102). Further, the planning reference date control section 112 performs a judgment processing for a simulation end flag obtained in the planning reference date control processing (S103). If the simulation end flag is set (Yes in S103), the output processing section 116 performs a processing of calculating an index and outputting a result (S108), and brings the flow to an end.

On the other hand, if the simulation end flag is not set (No in S103), the SCM calculation section 113 executes a supply chain planning calculation processing (S104). Then, the inventory calculation section 114 executes a problem-specific inventory calculation processing after SCM planning (S105). Further, the physical distribution calculation section 115 executes a physical distribution calculation processing (S106). Subsequently, the inventory calculation section 114 executes a problem-specific inventory calculation processing after the physical distribution calculation (S107). After that, the planning reference date control section 112 returns to Step S102 to resume the processing.

Hereinafter, the above-mentioned processings of Steps S101 to S108 are described in detail in order.

<Simulation Data Inputting Processing (S101 of FIG. 3)>

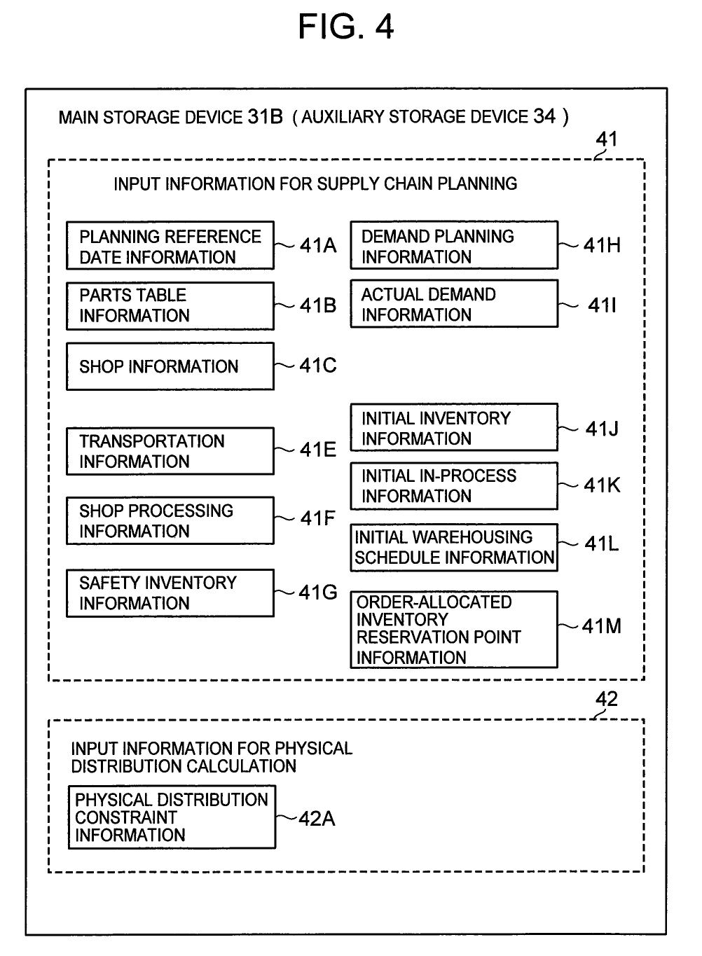

FIG. 4 illustrates the simulation data used for the simulation calculation in the subsequent processings. The input processing section 111 acquires the simulation data by receiving data input from the operator or via the portable recording medium or the external network 4, and stores the simulation data in the main storage device 31B or the auxiliary storage device 34. In Step S101, the input processing section 111 reads the simulation data from the main storage device 31B or the auxiliary storage device 34.

The simulation data mainly includes input information 41 used for the supply chain planning and input information 42 used for the physical distribution calculation.

The input information 41 for the supply chain planning includes planning reference date information 41A, parts table information 41B, shop information 41C, transportation information 41E, shop processing information 41F, safety inventory information 41G, demand planning information 41H, actual demand information 41I, initial inventory information 41J, initial in-process information 41K, initial warehousing schedule information 41L, and order-allocated inventory reservation point information 41M.

The input information 42 used for the physical distribution calculation includes physical distribution constraint information 42A.

Hereinafter, each of the above-mentioned information components is described in detail.

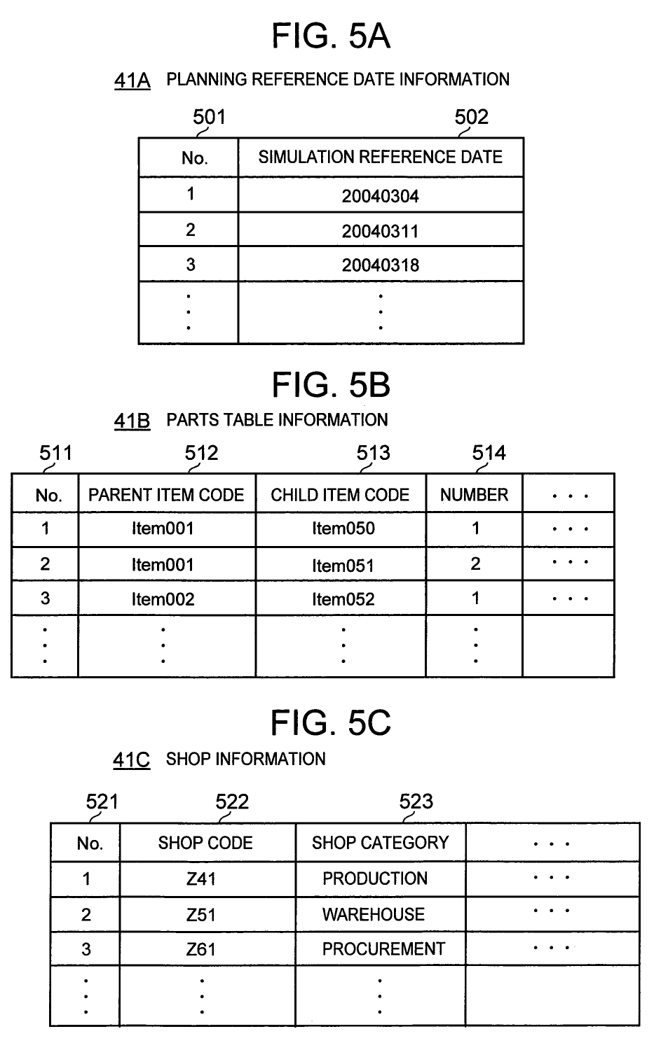

As illustrated in FIG. 5A, the planning reference date information 41A includes, in each record, a record number 501 and a simulation reference date 502. The simulation reference date 502 indicates a date on which the supply chain planning is put into practice. As a date for the simulation reference date 502, a certain date for every one week is determined and a number of such days are prepared for the simulation reference dates over one year. A simulation is executed on those prepared dates. Further, the data prepared above could be provided monthly-basis and/or weekly basis. Thus, a planning frequency of simulation could be flexibly controllable.

As illustrated in FIG. 5B, the parts table information 41B includes, in each record, a record number 511, a parent item code 512, a child item code 513, and a number 514. In other words, the parts table information 41B includes information on parent-child relationships between items in the procurement, the production, the warehouse, the shipment, and the customer.

As illustrated in FIG. 5C, the shop information 41C includes, in each record, a record number 521, a shop code 522, and a shop category 523. In other words, the shop information 41C includes information regarding shops and information regarding contents of shop processings.

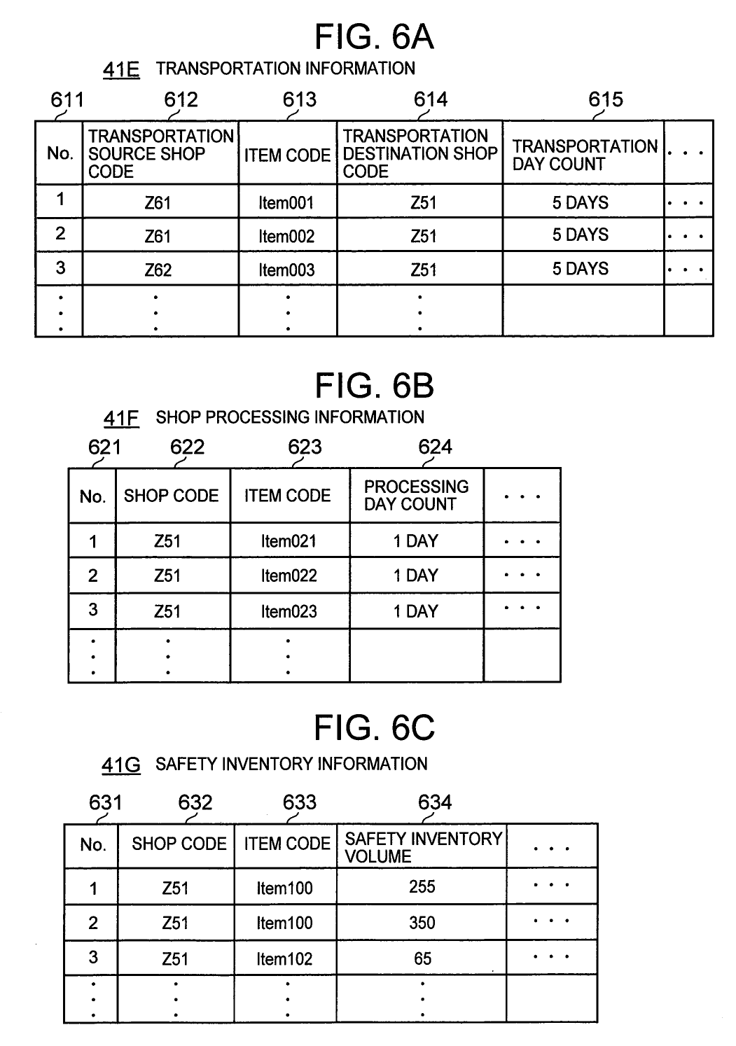

As illustrated in FIG. 6A, the transportation information 41E includes, in each record, a record number 611, a transportation source shop code 612, an item code 613, a transportation destination shop code 614, and a transportation day count 615. In other words, the transportation information 41E includes information regarding the transportation between shops.

As illustrated in FIG. 6B, the shop processing information 41F includes, in each record, a record number 621, a shop code 622, an item code 623, and a processing day count 624. In other words, the shop processing information 41F includes information regarding a processing day count for a shop and an item.

As illustrated in FIG. 6C, the safety inventory information 41G includes, in each record, a record number 631, a shop code 632, an item code 633, and a safety inventory volume 634. In other words, the safety inventory information 41G includes information regarding a safety inventory for a shop and an item.

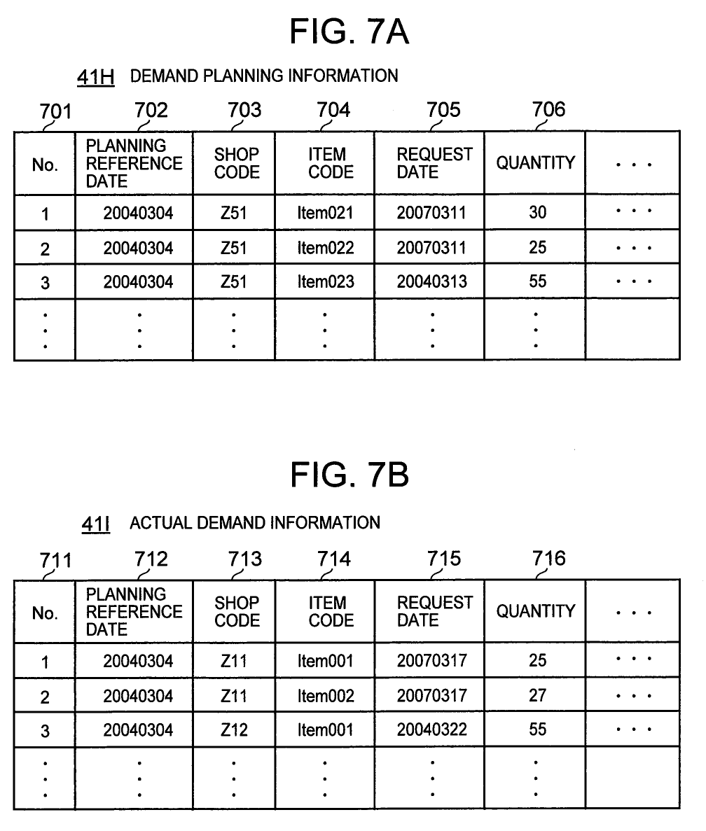

As illustrated in FIG. 7A, the demand planning information 41H includes, in each record, a record number 701, a planning reference date 702, a shop code 703, an item code 704, a request date 705, and a quantity 706. In other words, the demand planning information 41H includes information that represents an expectation plan indicating when and how many numbers of a given item requested by a shop is demanded in demand planning at the simulation reference date.

As illustrated in FIG. 7B, the actual demand information 41I includes, in each record, a record number 711, a planning reference date 712, a shop code 713, an item code 714, a request date 715, and a quantity 716. In other words, the actual demand information 41I includes order confirmation information indicating when and how many numbers of a given item requested by a shop is actually demanded at the simulation reference date.

Other than the above-mentioned information, the formulation of the supply chain planning also involves calendar information indicating a service day of each shop and shop capability information for performing a shop load heap plan, which do not constitute main points herein, and hence description thereof is omitted.

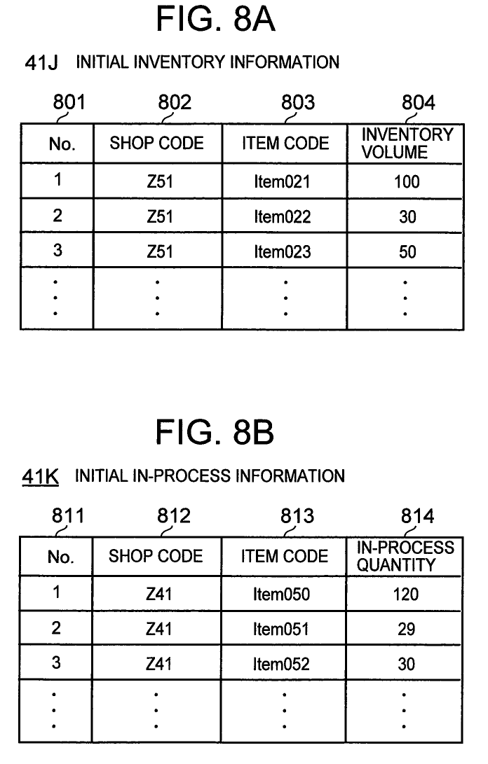

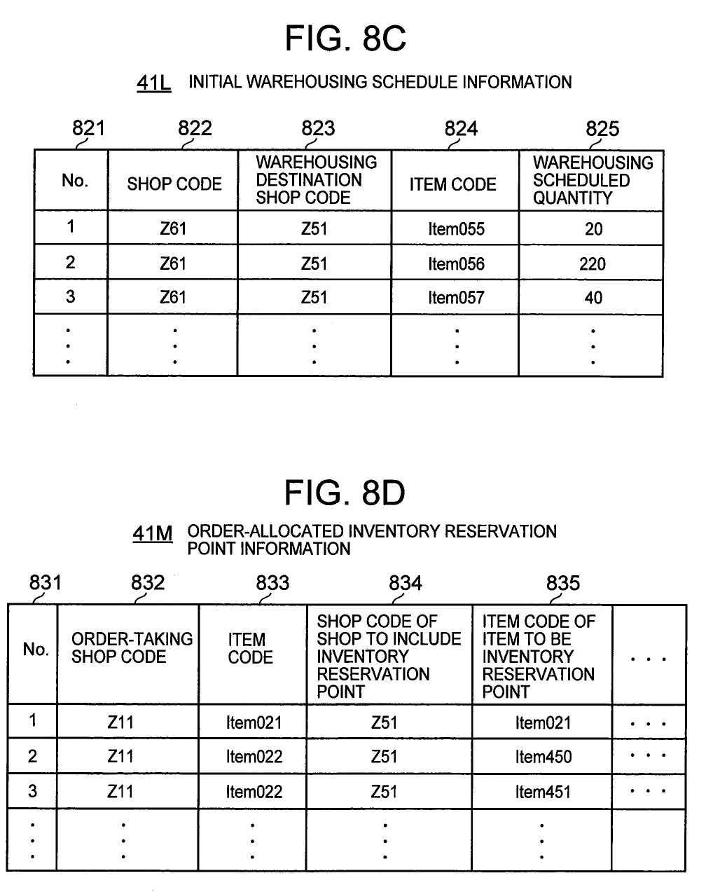

As illustrated in FIG. 8A, the initial inventory information 41J includes, in each record, a record number 801, a shop code 802, an item code 803, and an inventory volume 804. In other words, the initial inventory information 41J includes an initial inventory volume used at the start of a calculation for each shop and each item.

As illustrated in FIG. 8B, the initial in-process information 41K includes, in each record, a record number 811, a shop code 812, an item code 813, and an in-process quantity 814. In other words, the initial in-process information 41K includes a quantity of goods in process at a shop on a shop and item basis.

As illustrated in FIG. 8C, the initial warehousing schedule information 41L represents data of goods transferred between shops and warehoused into another shop, and includes, in each record, a record number 821, a shop code 822, a warehousing destination shop code 823, an item code 824, and a warehousing scheduled quantity 825. In other words, the initial warehousing schedule information 41L includes a quantity of items transferred between shops.

As illustrated in FIG. 8D, the order-allocated inventory reservation point information 41M includes, in each record, a record number 831, an order-taking shop code 832, an item code 833, a shop code 834 for specifying a position of an inventory reservation point, and an item code 835 of an item reserved as the inventory reservation point. For example, the record “No. 1” means that an item identified by “Z51” and “Item021” serves as the inventory reservation point for an item identified by “Z11” and “Item02”. The record “No. 2” means that, for an item identified by “Z11” and “Item022”, two child items thereof, namely, an item identified by “Z51” and “Item450” and an item identified by “Z51” and “Item451”, serve as the inventory reservation points. It is indicated that the production is then started with parts inventory reserved.

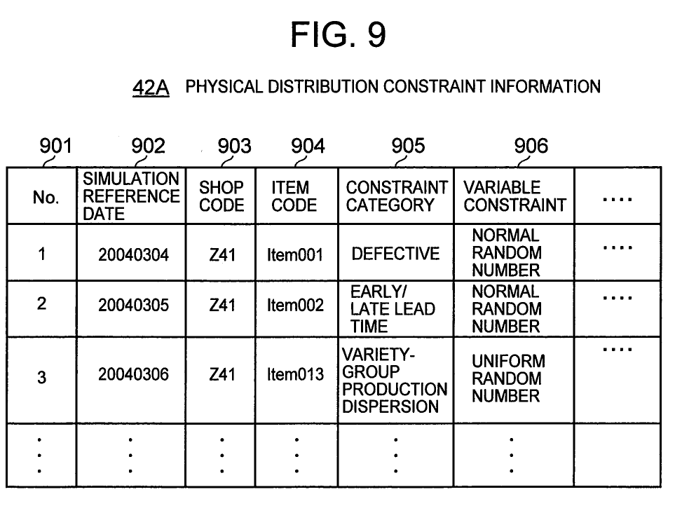

As illustrated in FIG. 9, the physical distribution constraint information 42A includes, in each record, a record number 901, a simulation reference date 902, a shop code 903, an item code 904, a constraint category 905, and a variable constraint 906. In other words, the physical distribution constraint information 42A includes a parameter for changing the physical distribution according to a simulation period in the physical distribution calculation.

Hereinabove, each of the above-mentioned information components illustrated in FIG. 4 is described.

<Planning Reference Date Control Processing (S102 of FIG. 3)>

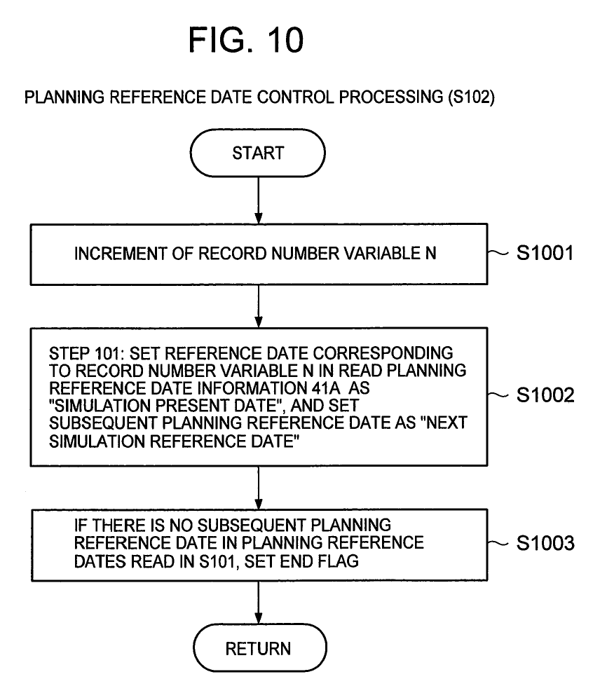

Next, description is made of the planning reference date control processing. FIG. 10 illustrates a flow of the planning reference date control processing. First, the planning reference date control section 112 increments a record number variable N (initial value=0) for selecting the planning reference date to be processed (S1001). Next, the planning reference date control section 112 identifies, from the planning reference date information 41A read in Step S101, the simulation reference date 502 of a record with the record number 501 as the record number variable N, and sets the identified simulation reference date 502 as a “simulation present date”. In addition, the planning reference date control section 112 identifies the simulation reference date 502 corresponding to the record number 501 subsequent to the record number variable N, and sets the identified simulation reference date 502 as a “next simulation reference date” (S1002).

Herein, if there is no record corresponding to the record number 501 subsequent to the record number variable N in the planning reference date information 41A read in Step S101 (or if the simulation reference date 502 is not stored in the corresponding record), the planning reference date control section 112 sets the “simulation end flag” (S1003). Then, the processing of Step S102 is brought to an end.

<Supply Chain Planning Calculation Processing (S104 of FIG. 3)>

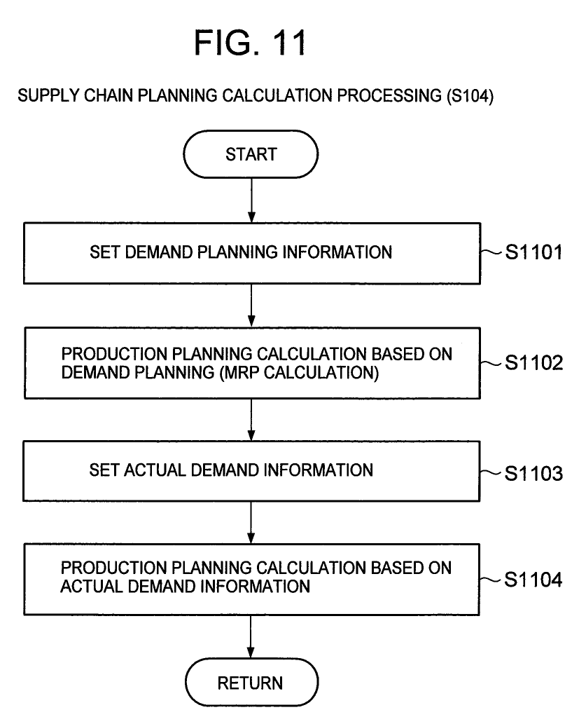

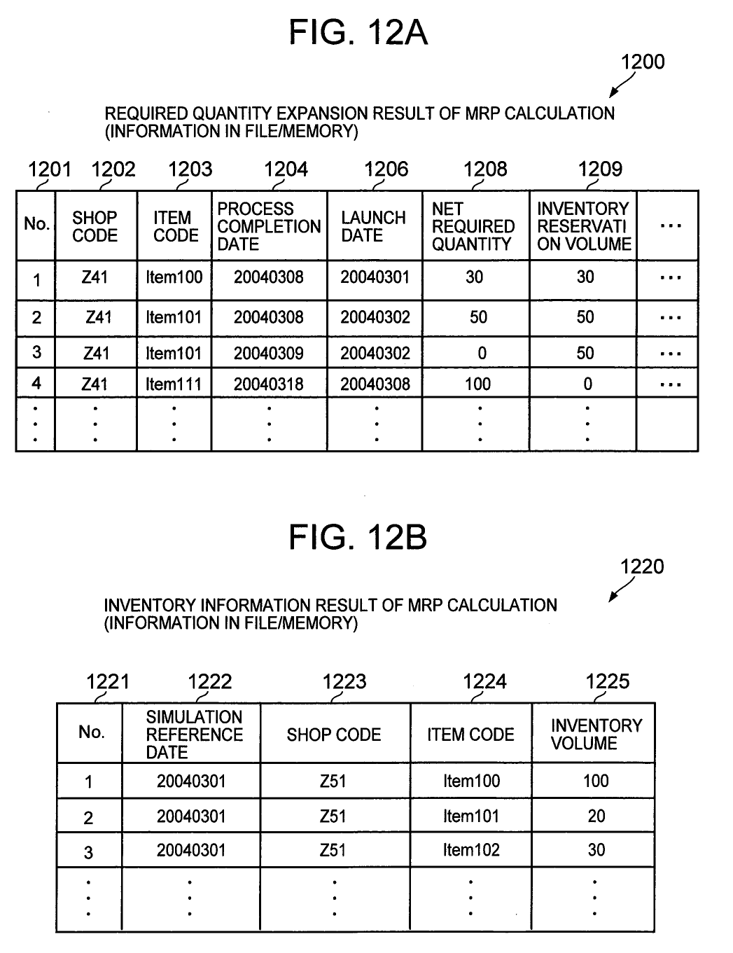

FIG. 11 is a flowchart of a supply chain planning calculation processing. The SCM calculation section 113 first sets the demand planning information 41H (S1101). Then, the SCM calculation section 113 executes a production planning calculation based on the demand planning (S1102). The production planning calculation is performed by a method using a calculation logic of a so-called material requirements planning (MRP). The method is as well-known as disclosed in “MRP for SE” (Noboru, Toriba; Nikkan Kogyo Shimbun Ltd.), and detailed processings therefor are omitted herein, but in the method, such a required quantity as when and by which quantity each item is produced at which shop is formulated based on the input information 41 for the supply chain planning. FIGS. 12A and 12B illustrate images of outputs from such an MRP calculation.

A required quantity expansion result 1200 includes, in each record, a record number 1201, a shop code 1202, an item code 1203, a process completion date 1204, a launch date 1206, a net required quantity 1208, an inventory reservation volume 1209, and other such information. For example, the record “No. 1” means the following. That is, at the shop “Z41”, the item “Item100” is manufactured. The launch date for manufacturing is Mar. 1, 2004 (“20040301”), and the manufacturing completion date is Mar. 8, 2004. The required quantity of the manufactured item “Item100” is “60”. 30 thereof are covered by a previously-manufactured stock of the inventory, and hence the net required quantity is “30”.

It should be noted that the SCM calculation section 113 outputs a plan corresponding to an upstream of an order-allocated reservation point identified in the order-allocated inventory reservation point information 41M illustrated in FIG. 8D. In other words, a plan corresponding to a range from a procurement destination before the inventory reservation point is outputted. For example, referring to the supply chain model illustrated in FIG. 1, the warehouse Z51 subsequent to a procurement site is the order-allocated inventory reservation point, and hence the SCM calculation section 113 outputs a plan corresponding to a range up to the procurement sites Z61 and Z62.

In the same manner as the production planning calculation performed in Steps S1101 and S1102, the SCM calculation section 113 performs a calculation based on the actual demand information 41I (S1103 and S1104), and calculates the required quantity corresponding to a range beyond the order-allocated reservation point identified in the order-allocated inventory reservation point information 41M illustrated in FIG. 8D. In other words, the required quantity corresponding to a range up to the shops indicating the customers is calculated. Referring to the example model illustrated in FIG. 1, the calculation is performed for the shops corresponding to the customers Z11, Z12, and Z13 ranging in downstream direction from the warehouse Z51.

Along with the required quantity expansion result 1200, as illustrated in FIG. 12B, the SCM calculation section 113 outputs an inventory information result (inventory information result of MRP calculation) 1220 as of the simulation present date. As illustrated in FIG. 12B, the inventory information result 1220 includes, in each record, a record number 1221, a simulation reference date 1222, a shop code 1223, an item code 1224, and an inventory volume 1225.

Then, the SCM calculation section 113 brings the processing of Step S104 to an end.

<Problem-Specific Inventory Calculation Processing after SCM Planning (S105 of FIG. 3)>

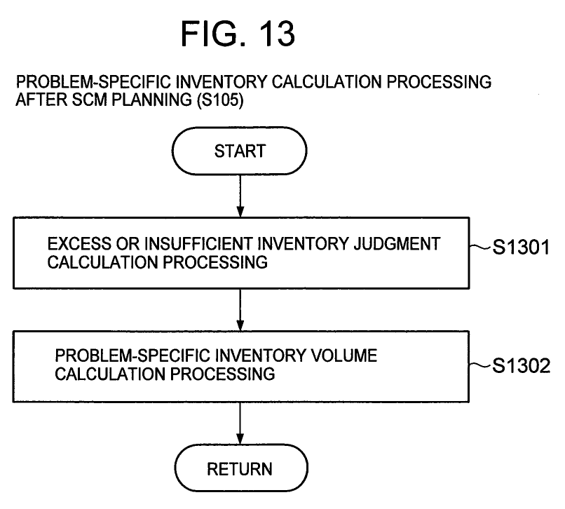

FIG. 13 is a flowchart of the problem-specific inventory calculation processing after the SCM planning. The inventory calculation section 114 first executes an excess or insufficient inventory judgment calculation processing in Step S1301. Then, the inventory calculation section 114 executes a problem-specific inventory volume calculation processing after the SCM planning in Step S1302. Hereinafter, an outline of each of the processings is described.

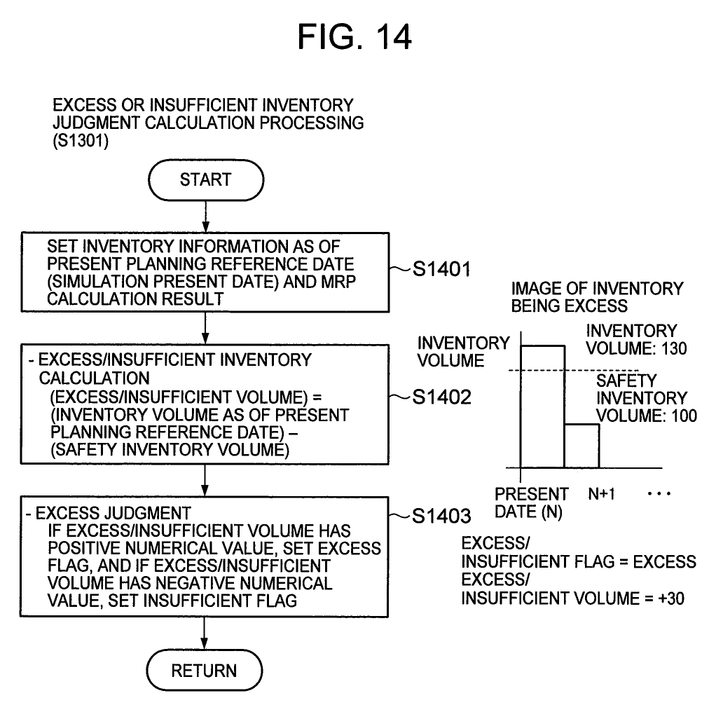

FIG. 14 is a flowchart of the excess or insufficient inventory judgment calculation processing (S1301 of FIG. 13). It should be noted that an image of the calculation is illustrated on the right side of the flowchart. First, the inventory calculation section 114 sets the inventory information result 1220 as of the simulation 15, present date to be used for a calculation herein (S1401). Subsequently, for each record, as an excess/insufficient inventory calculation, the inventory calculation section 114 subtracts the safety inventory volume from the inventory volume as of the simulation present date (S1402). Then, for each record, the inventory calculation section 114 performs an excess judgment, and if an excess/insufficient volume has a positive numerical value, sets an excess flag, and if the excess/insufficient volume has a negative numerical value, sets an insufficient flag (S1403), and brings the calculation flow to an end. In other words, the inventory calculation section 114 performs processings of Steps S1402 and S1403 for each record of the inventory information result 1220 illustrated in FIG. 12B, sets the excess flag or the insufficient flag (“excess” or “insufficient”), and brings the flow to an end. It should be noted that the excess flag and the insufficient flag are used by the output processing section 116 to display the excess/insufficient state of the inventory volume.

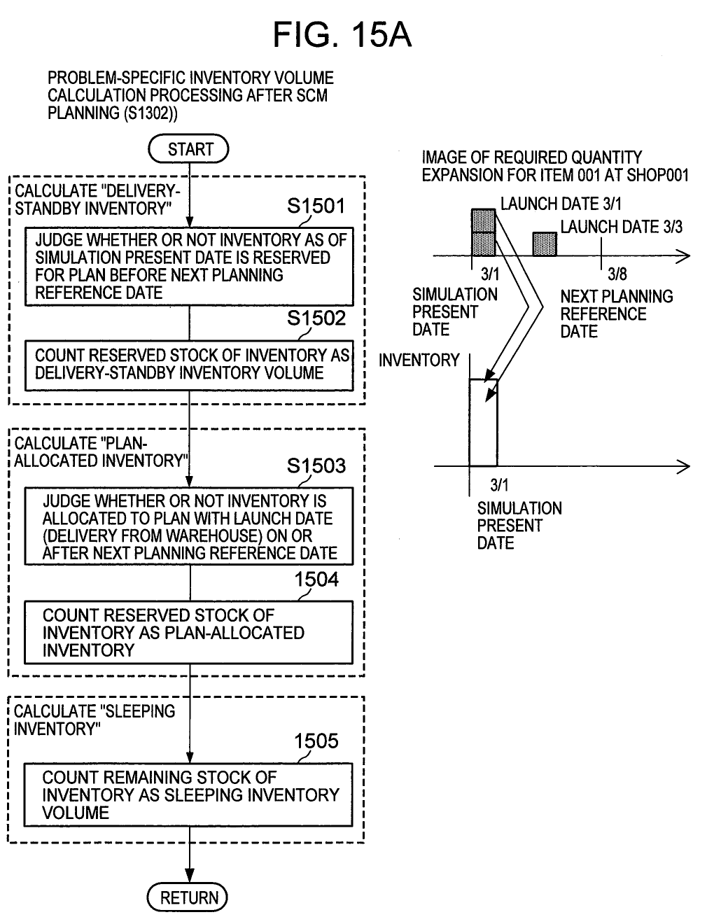

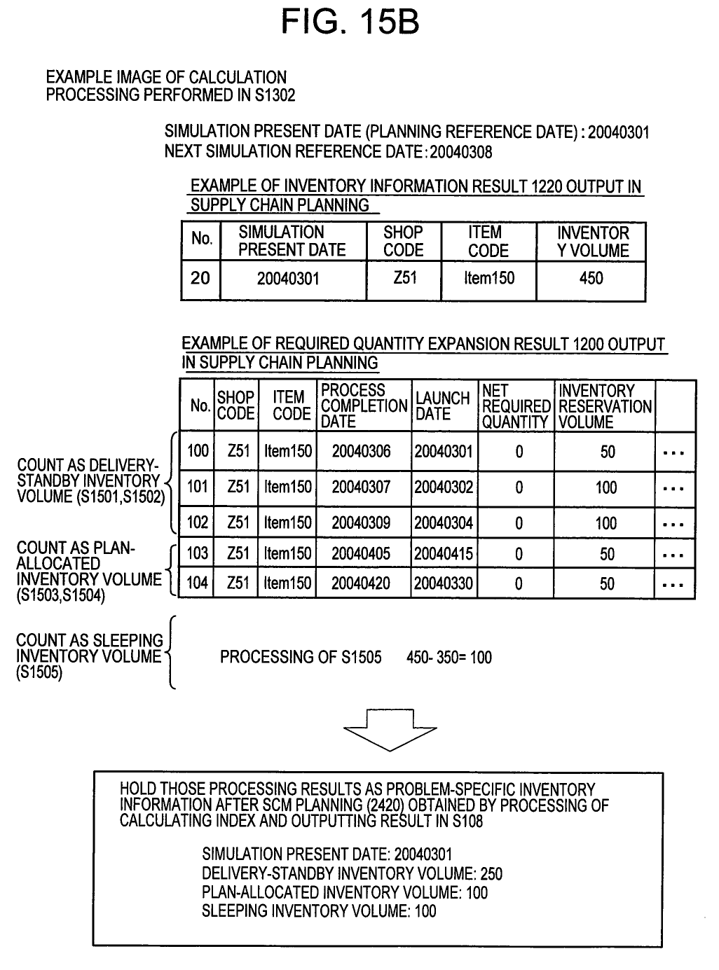

FIG. 15A is a flowchart of the problem-specific inventory volume calculation processing after the SCM planning (S1302 of FIG. 13). It should be noted that images of the calculation are illustrated on the right side of the flowchart of FIG. 15A and in FIG. 15B.

The inventory calculation section 114 performs the flow for each record of the inventory information result 1220. The inventory calculation section 114 judges whether or not the inventory as of the simulation present date corresponds to: (1) a “delivery-standby inventory” reserved for the fixed plan; (2) a “plan-allocated inventory” reserved for a future plan subject to change; or (3) a “sleeping inventory” that is not reserved even for the future plan, and calculates a quantity for each case.

In other words, the inventory calculation section 114 first judges whether or not the inventory as of the simulation present date is reserved as the inventory for a plan (required quantity) corresponding to a period until the next simulation reference date (herein, referred to as “target period”) (S1501). To be specific, the inventory calculation section 114 judges based on the required quantity expansion result 1200 of the MRP calculation illustrated in FIG. 12A whether or not the launch date 1206 falls within the “target period”. Then, the inventory calculation section 114 counts the stock of the inventory reserved as the inventory as of the simulation present date corresponding to a record having the launch date 1206 within the “target period”, and holds its count data as a “delivery-standby inventory volume” (S1502).

Subsequently, the inventory calculation section 114 extracts the future plan subject to change, corresponding to a record whose launch date 1206 does not fall within the “target period”, namely, starting from the next simulation reference date, and judges whether or not the plan is allocated to the inventory as of the simulation reference date (S1503). Then, the inventory calculation section 114 holds data on the allocation as the “plan-allocated inventory volume” (S1504).

On the other hand, the inventory calculation section 114 counts the stock of the remaining inventory that is not reserved for a plan, and holds its count data as a “sleeping inventory volume” (S1505). It should be noted that the sleeping inventory volume may be held as data by defining a method of counting as sleeping, for example, counting if the inventory has been reserved for no plan for one month.

Then, the inventory calculation section 114 brings the processing of Step S105 to an end.

<Physical Distribution Calculation Processing (S106 of FIG. 3)>

Next, description is made of an outline of the physical distribution calculation processing. In the physical distribution calculation, the flow of goods from the procurement up to the delivery to the customer is simulated based on a plan corresponding to a record having the launch date 1206 before the next simulation reference date, in response to the required quantity expansion result 1200 of the MRP calculation illustrated in FIG. 12A being the supply chain planning. For example, if the present simulation reference date is March 4, and if a reference date on which the next supply chain planning is put into practice is March 11, a record having a date that falls within a period from March 4 through March 10 is extracted from the required quantity expansion result 1200, followed by the execution of the physical distribution calculation.

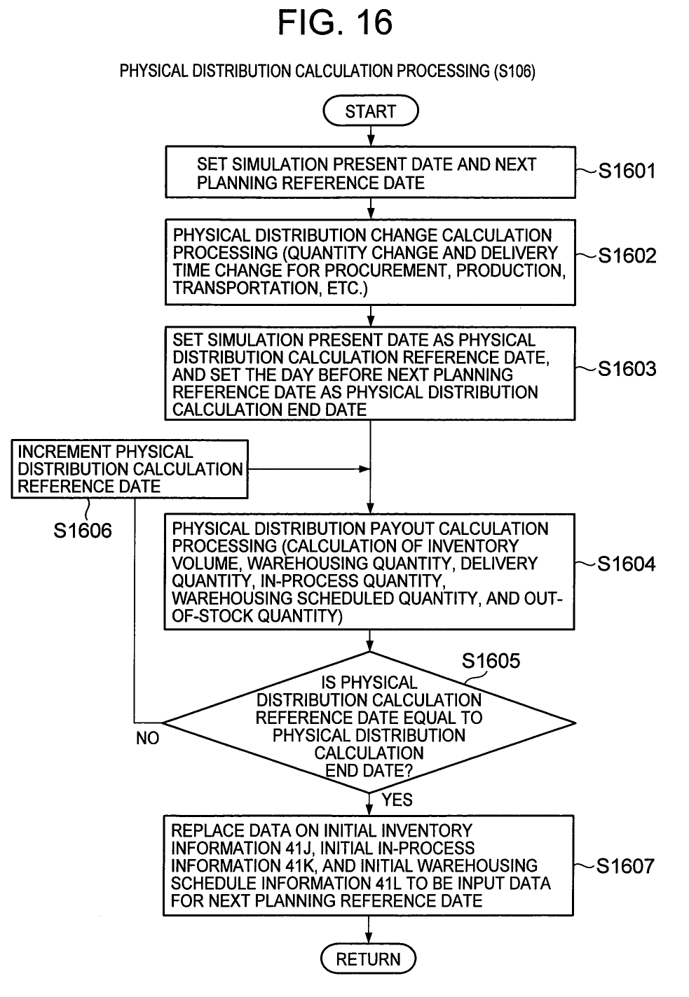

FIG. 16 is a flowchart of the physical distribution calculation. First, an outline thereof is described. The physical distribution calculation section 115 sets the “simulation present date (simulation reference date that is present date of simulation)” set in Step S1002 and the “next simulation reference date” being the next planning reference date (S1601). Subsequently, based on the two reference dates and the required quantity expansion result 1200 of FIG. 12A obtained in the supply chain planning calculation processing (S104), the physical distribution calculation section 115 executes a physical distribution change calculation processing, which is described later (S1602). In response to a result thereof, the physical distribution calculation section 115 performs a physical distribution payout processing in units of days for warehousing, delivery, an in-process quantity, and the like of the physical distribution in Steps S1603 to S1606.

In other words, as a preprocessing, the physical distribution calculation section 115 sets the “simulation present date” as a “physical distribution calculation reference date”, and sets the day before the “next simulation reference date” as a “physical distribution calculation end date” (S1603). Subsequently, the physical distribution calculation section 115 performs a physical distribution payout calculation processing for an inventory of each item at each shop, warehousing, delivery, in-process, out-of-stock, and the like (S1604). Then, the physical distribution calculation section 115 judges whether or not the physical distribution calculation reference date is equal to the physical distribution calculation end date (S1605), and while incrementing the physical distribution calculation reference date, performs the processing of Step S1604 repeatedly until the two dates become equal to each other (S1606). If the physical distribution calculation reference date becomes equal to the physical distribution calculation end date (Yes in S1605), the physical distribution calculation section 115 replaces the obtained inventory volume, in-process quantity, and warehousing scheduled quantity as the initial value of input data for the next supply chain planning (S1607), and brings the flow to an end.

Next, each processing thereof is described in detail.

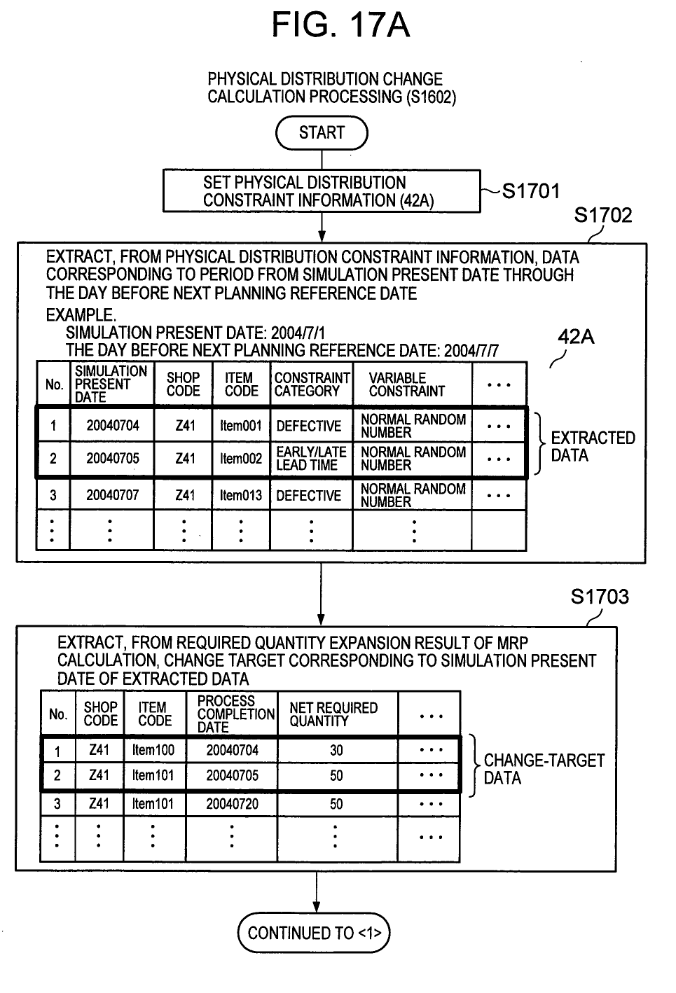

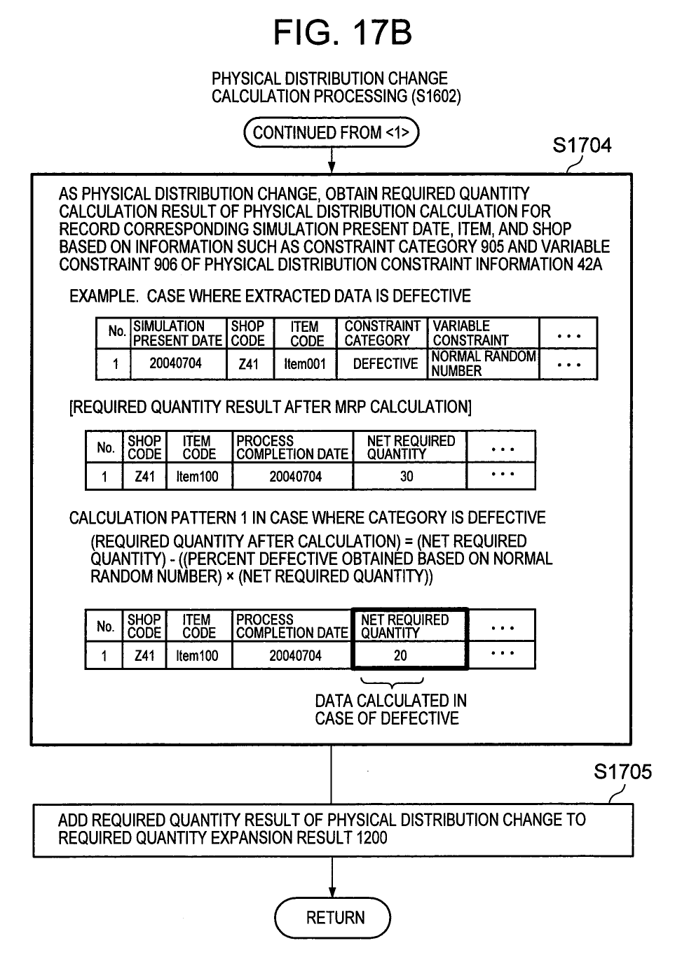

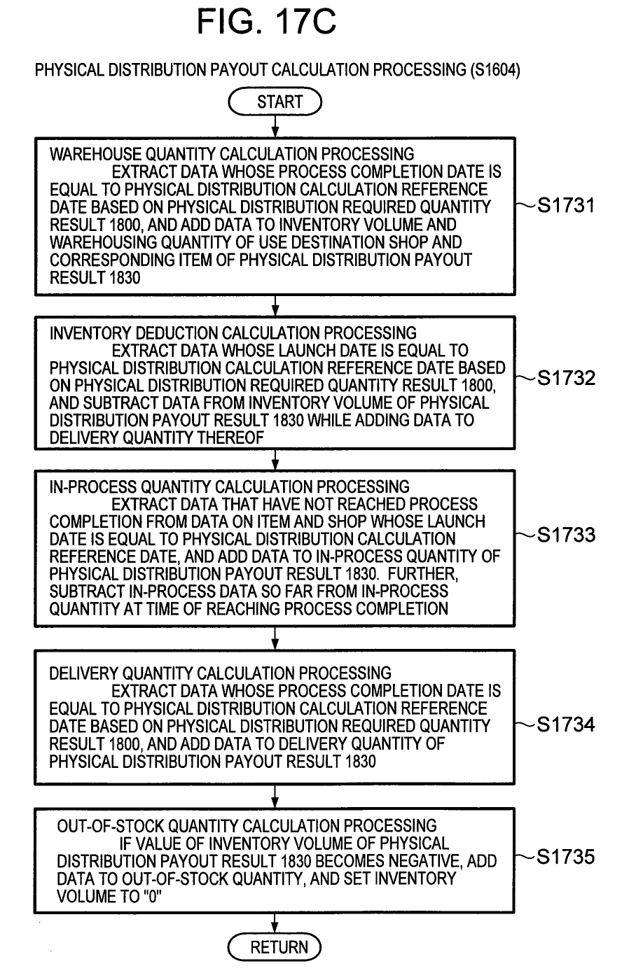

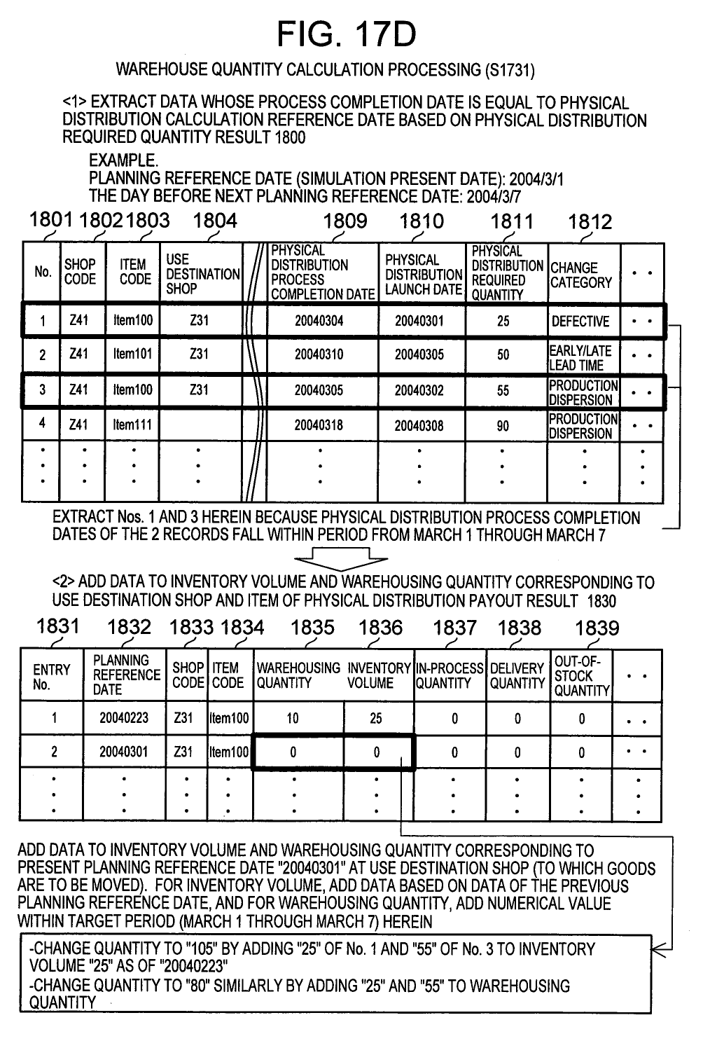

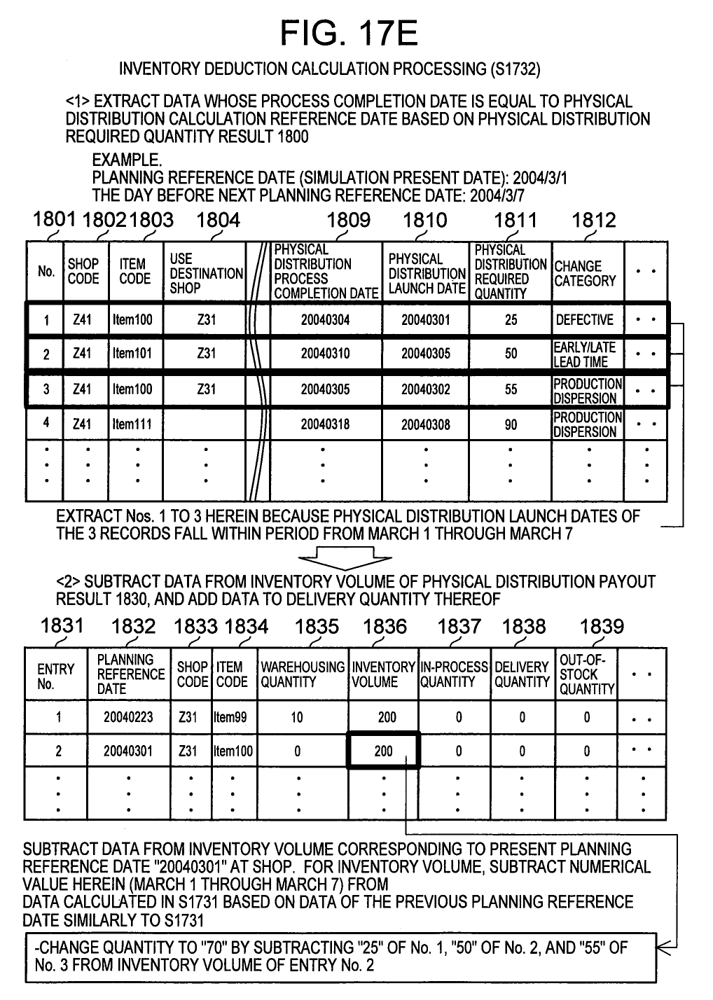

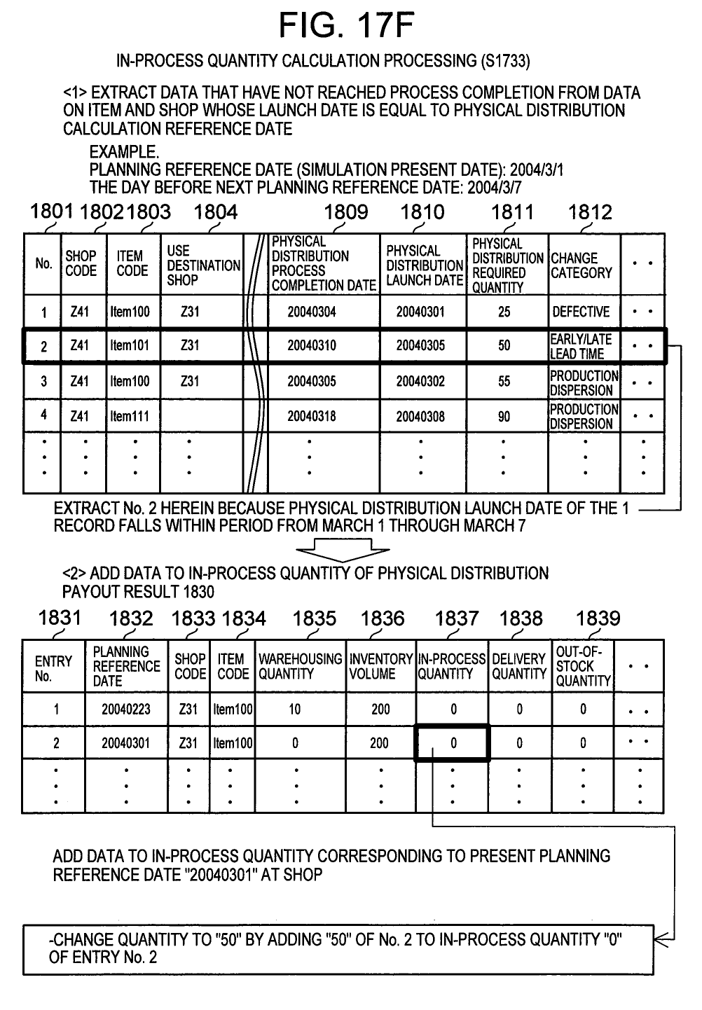

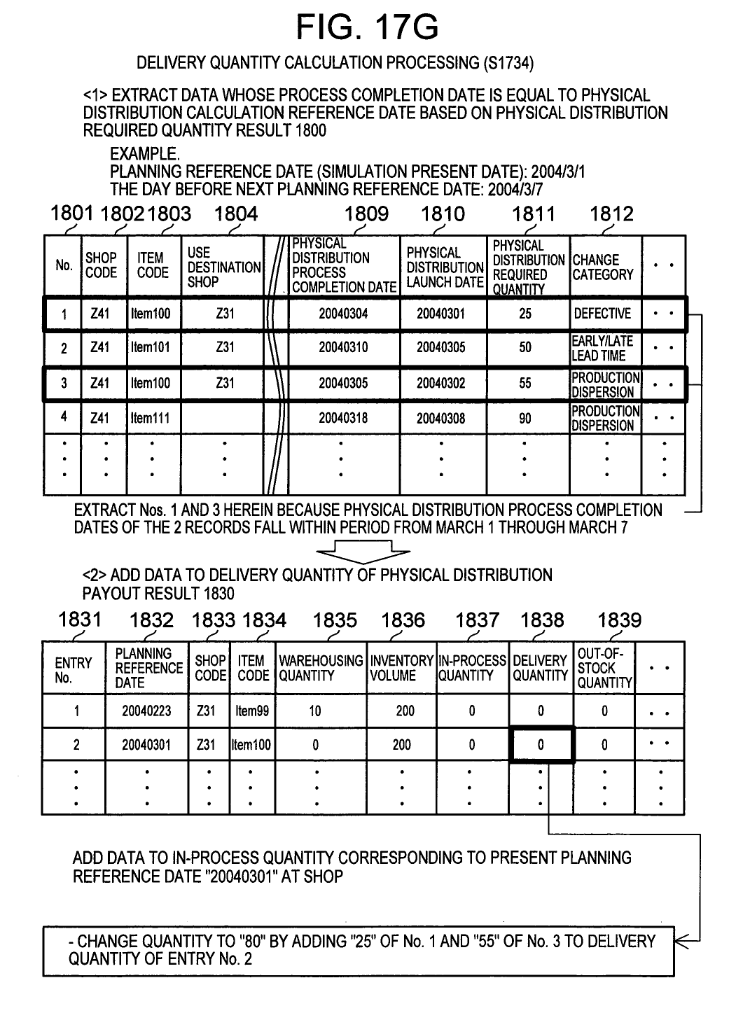

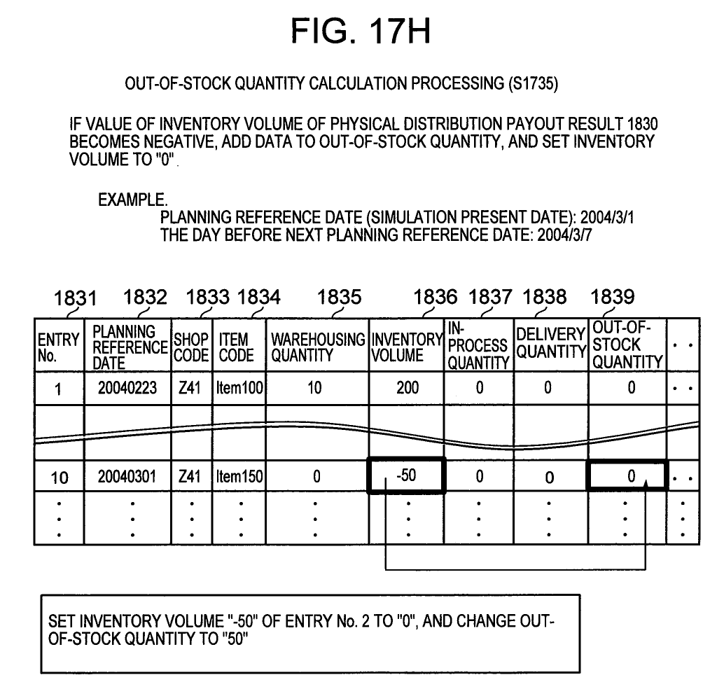

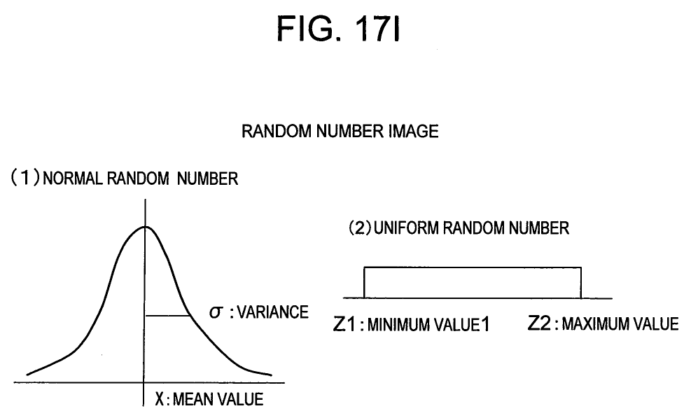

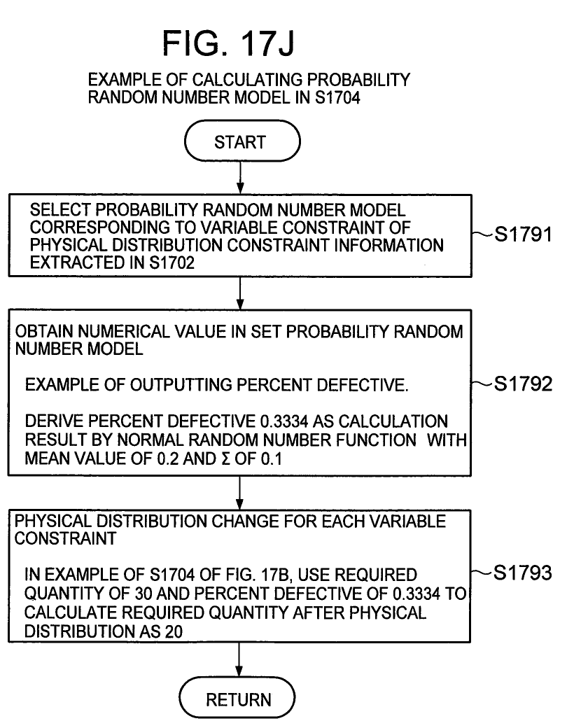

FIGS. 17A and 17B illustrate an example flow of the physical distribution change calculation processing (S1602 of FIG. 16). The physical distribution calculation section 115 first sets the physical distribution constraint information 42A of FIG. 9 which includes a setting parameter for a physical distribution change (S1701).

Subsequently, the physical distribution calculation section 115 extracts data on a physical distribution constraint corresponding to a period from the “simulation present date” through the day before the “next simulation reference date” from the physical distribution constraint information 42A (S1702). For example, in the example illustrated in FIG. 17A, if the “simulation present date” is Jul. 1, 2004, and if the day before the “next simulation reference date” is Jul. 6, 2004, data of the records “No. 1” and “No. 2” is extracted from the physical distribution constraint information 42A.

Subsequently, the physical distribution calculation section 115 extracts, from the required quantity expansion result 1200 which is the output of the MRP calculation, data on a target of the physical distribution change corresponding to the “simulation present date” of the extracted data (S1703). In this example, data of the two records “No. 1” and “No. 2” each including the same shop, the same item, and the same process completion date, is extracted. It should be noted that a condition therefor may be set on a shop basis, an item basis, a process completion date basis, a launch date basis, or a planning reference date basis.

Subsequently, as the physical distribution change, the physical distribution calculation section 115 obtains a required quantity calculation result of the physical distribution calculation for the corresponding record based on information such as the constraint category 905 and the variable constraint 906 of the physical distribution constraint information 42A (S1704). For example, if the constraint category of the extracted data is “defective”, the physical distribution calculation section 115 may calculate a defective count by using a percent defective obtained with a normal random number based on the net required quantity of the result obtained from the MRP calculation, to thereby obtain a changed net required quantity. Alternatively, in a case of the constraint category “early/late lead time”, the physical distribution calculation section 115 executes a physical distribution change processing by, for example, changing the process completion date, based on information defined in the physical distribution constraint information 42A.

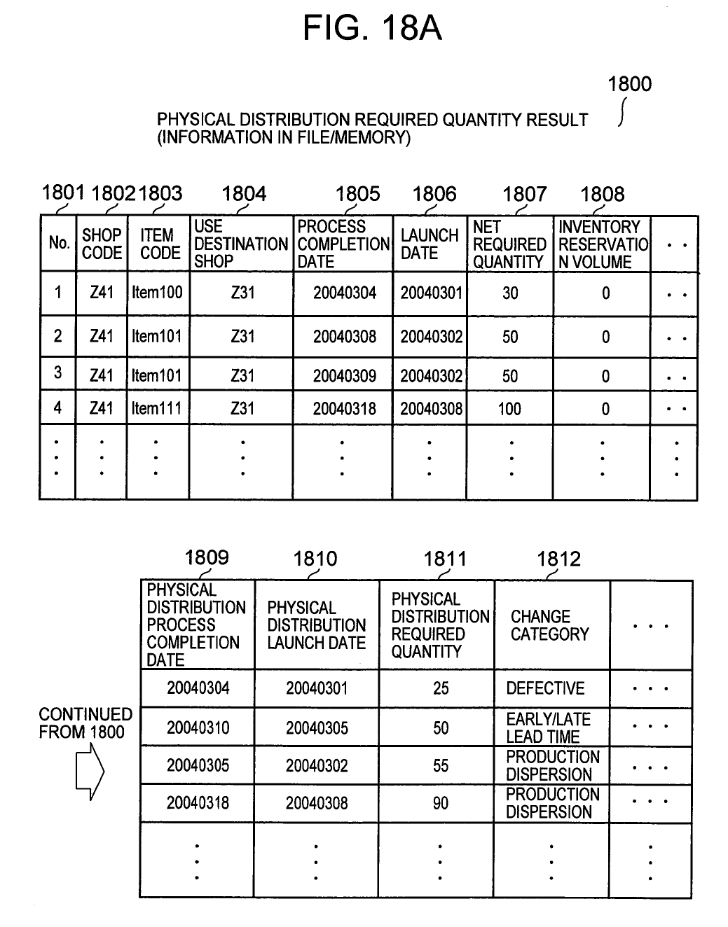

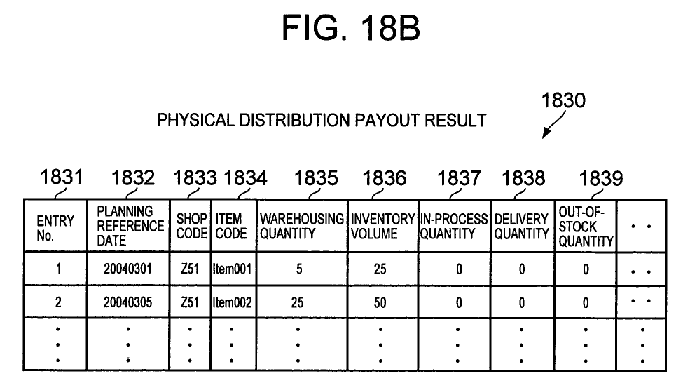

Then, according to the physical distribution constraint, the physical distribution calculation section 115 adds a physical distribution required quantity result to the required quantity expansion result 1200 (S1705), and outputs a physical distribution required quantity result 1800 as illustrated in FIG. 18A.

The physical distribution required quantity result 1800 includes, in each record, in addition to data pieces corresponding to those of the required quantity expansion result 1200 (namely, record number 1801, shop code 1802, item code 1803, process completion date 1805, launch date 1806, net required quantity 1807, and inventory reservation volume 1808), a physical distribution process completion date 1809, a physical distribution launch date 1810, a physical distribution required quantity 1811, and a change category 1812. It should be noted that the physical distribution required quantity result 1800 further includes a use destination shop 1804 at which an item identified by the shop code 1802 and an item code 1803 is used.

Herein, description is made of the physical distribution change using a probability variable in Step S1704. FIG. 17I illustrates two images of the normal random number and a uniform random number. FIG. 17J illustrates a flow of the physical distribution calculation using the probability variable. As illustrated in (1) of FIG. 17I, the normal random number forms a distribution model that is most often used among continuous distributions and uses a mean value x and a variance σ. On the other hand, as illustrated in (2) of FIG. 17I, the uniform random number forms a distribution model that develops with a uniform probability between a numerical value interval between a minimum value Z1 and a maximum value Z2. For example, those distribution models have their function expressions appear in the book “Elementary Statistics” (Miyakawa, Tadao; Yuhikaku Publishing Co., Ltd.) and the like, and are generally used as standard functions for Microsoft Corporation's spreadsheet software “Excel” and the like. Therefore, detailed description of logics thereof is omitted herein.

FIG. 17J is used to briefly describe a flow performed in this case.

The physical distribution calculation section 115 selects a probability random number model corresponding to the variable constraint of the physical distribution constraint information 42A extracted in Step S1702 (S1791). Subsequently, the physical distribution calculation section 115 obtains a numerical value in the set probability random number model (S1792). For example, in Step S1704, which shows an example of obtaining the percent defective based on the normal random number, the numerical value 0.3334 is obtained as a calculation result by a normal random number function based on the normal random number with the mean value of 0.2 and the variance a of 0.1, which are previously set. It should be noted that the numerical value is subjected to change randomly depending on a normal distribution. The physical distribution calculation section 115 uses the percent defective obtained here to perform the physical distribution change for each variable constraint (S1793). In the example of Step S1704, the physical distribution calculation section 115 uses the percent defective of 0.3334 against the required quantity of 30, resulting in the defective quantity of 10, and thus obtains the required quantity of 20. The above description is directed only to the case of the constraint category “defective” and the variable constraint “normal random number”, but the required quantity can also be obtained in a similar manner in a case where the constraint category is “early/late lead time” and a case where the variable constraint (random number) is “uniform random number”. Alternatively, another distribution and the like may be used, or a random number parameter may be set for each entry number of the physical distribution constraint information 42A.

Next, description is made of the physical distribution payout calculation processing (S1604 of FIG. 16). FIG. 17C is a flowchart of the above-mentioned processing, showing an example where the physical distribution required quantity result 1800 is used to calculate the flow of goods on a process basis and an item basis from the physical distribution calculation reference date through the physical distribution calculation end date, which are set in Step S1603, in units of days.

By the above-mentioned processing, a physical distribution payout result 1830 is output as illustrated in FIG. 18B. The physical distribution payout result 1830 includes, in each record, a entry number 1831, the planning reference date 1832, a shop code 1833, an item code 1834, a warehousing quantity 1835, an inventory volume 1836, an in-process quantity 1837, a delivery quantity 1838, and an out-of-stock quantity 1839. In this example, at intervals of the planning reference date, results of the inventory holding, warehousing, delivery, in-process, out-of-stock, and the like which are paid out from the physical distribution on an item basis and a shop basis are outputted.

First, the physical distribution calculation section 115 performs a warehouse quantity calculation processing (S1731). FIG. 17D is a diagram for describing the above-mentioned processing. The physical distribution calculation section 115 extracts a record having the process completion date 1805 equal to the physical distribution calculation reference date from data of the physical distribution required quantity result 1800, and obtains a total sum value of the physical distribution required quantity 1811 of the extracted records. Then, the physical distribution payout result 1830 is updated by adding the total sum value to each of the warehousing quantity 1835 and the inventory volume 1836 corresponding to a warehousing destination shop to which goods are flowed and the item. Next, the physical distribution calculation section 115 performs an inventory deduction calculation processing (S1732). FIG. 17E is a diagram for describing the above-mentioned processing. The physical distribution calculation section 115 extracts a record having the launch date 1806 equal to the physical distribution calculation reference date from data of the physical distribution required quantity result 1800, and obtains a total sum value of the physical distribution required quantity 1811 of the extracted records. Then, the physical distribution calculation section 115 updates the physical distribution payout result 1830 by subtracting the total sum value from the inventory volume 1836 on a shop basis and an item basis and also adding the total sum value to the delivery quantity 1838.

Subsequently, the physical distribution calculation section 115 performs an in-process quantity calculation processing (S1733). FIG. 17F is a diagram for describing the above-mentioned processing. The physical distribution calculation section 115 extracts a record having the launch date 1806 equal to the physical distribution calculation reference date, and performs an update by adding the total sum value of the physical distribution required quantity 1811 of records that have not reached process completion to the in-process quantity 1837. It should be noted that the in-process quantity so far is subtracted from the in-process quantity 1837 at a time of reaching the process completion.

Subsequently, the physical distribution calculation section 115 performs a delivery quantity calculation processing (S1734). FIG. 17G is a diagram for describing the above-mentioned processing. The physical distribution calculation section 115 extracts a record having the process completion date 1805 equal to the physical distribution calculation reference date, and performs an update by subtracting the total sum value of the physical distribution required quantity 1811 of the extracted records from the inventory volume 1836 on a shop basis and an item basis and also adding the total sum value to the delivery quantity 1838.

Finally, the physical distribution calculation section 115 performs an out-of-stock quantity calculation processing (S1735). FIG. 17H is a diagram for describing the above-mentioned processing. If the value of the inventory volume becomes negative in Step S1732, the physical distribution calculation section 115 adds the data to the out-of-stock quantity 1839, and sets the inventory volume 1836 to “0”.

The output result obtained by executing the above-mentioned processings is exemplified as the physical distribution payout result 1830 of FIG. 18B.

<Problem-Specific Inventory Calculation Processing after Physical Distribution Calculation (S107 of FIG. 3)>

Next, description is made of the problem-specific inventory calculation processing after the physical distribution calculation. In Step S105, the problem-specific inventory calculation processing after the SCM planning is performed to handle an excess/insufficient inventory problem from the viewpoint of the supply chain planning, while herein a calculation processing is performed to handle the excess/insufficient inventory problem from the viewpoint of a physical distribution side.

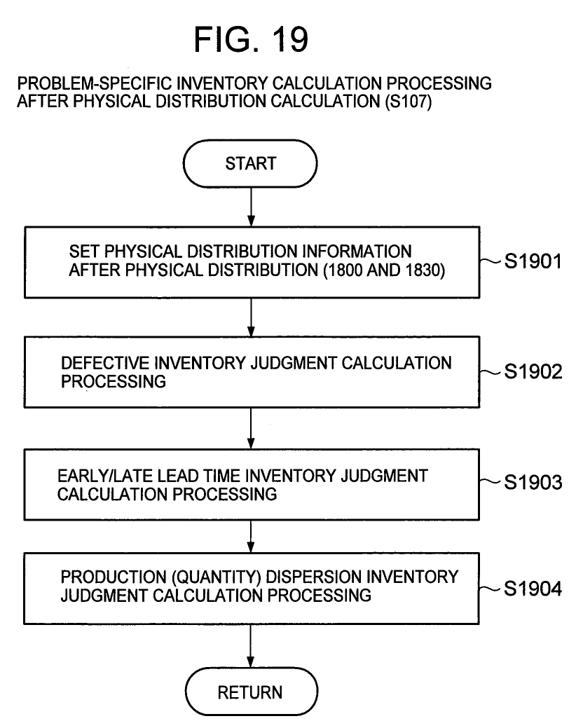

FIG. 19 is a flowchart of the above-mentioned processing. First, the inventory calculation section 114 sets the physical distribution required quantity result 1800 of FIG. 18A and a physical distribution payout result 1830 of FIG. 18B (S1901). Then, the inventory calculation section 114 executes a defective inventory judgment calculation processing (S1902), an early/late lead time judgment calculation processing (S1903), and a production (quantity) dispersion judgment calculation processing (S1904).

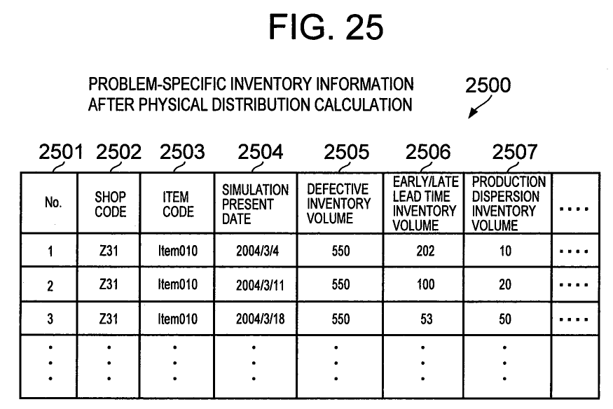

By the above-mentioned series of processings, problem-specific inventory information after the physical distribution calculation 2500 is output as illustrated in FIG. 25. The problem-specific inventory information after the physical distribution calculation 2500 includes, in each record, a record number 2501, a shop code 2502, an item code 2503, a simulation present date 2504, and a group of indices such as a defective inventory volume 2505, an early/late lead time inventory volume 2506, and a production dispersion inventory volume 2507.

Hereinafter, each of the processings is described in detail.

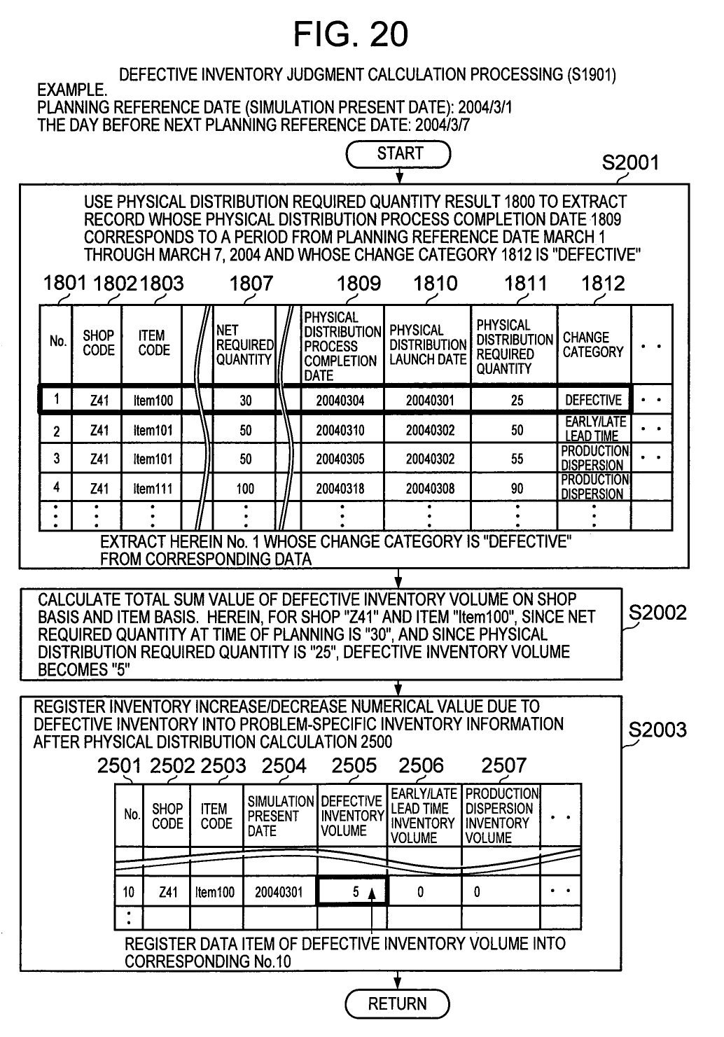

FIG. 20 is a flowchart of the defective inventory judgment calculation processing (S1902). This example shows a processing image in a case where the planning reference date, namely, the simulation present date is Mar. 1, 2004, and where the day before the next planning reference date is Mar. 7, 2004. First, the inventory calculation section 114 extracts, from the physical distribution required quantity result 1800, a record whose physical distribution process completion date 1809 corresponds to a period (from Mar. 1, 2004 through Mar. 7, 2004) from the planning reference date through the day before the next planning reference date and whose change category 1812 is “defective” (S2001). In the example of FIG. 20, as the corresponding data, the record “No. 1” is extracted.

Subsequently, the inventory calculation section 114 calculates a total sum value of the inventory volume corresponding to the change category “defective” on a shop basis and an item basis (S2002). In the example of FIG. 20, the shop “Z41” and the item “Item100”, which are extracted in Step S2001, are chosen, since the net required quantity at the time of planning is “30”, and since the physical distribution required quantity is “25”, and thus, the defective inventory volume becomes “5”.

Then, the inventory calculation section 114 registers an inventory increase/decrease numerical value corresponding to the defective inventory volume into the problem-specific inventory information after the physical distribution calculation 2500 (S2003), and returns to the flow of FIG. 19. In this example, the calculated “5” is registered as the “defective inventory volume 2505” corresponding to the shop “Z41”, the item “Item100”, and the simulation present date “Mar. 1, 2004”.

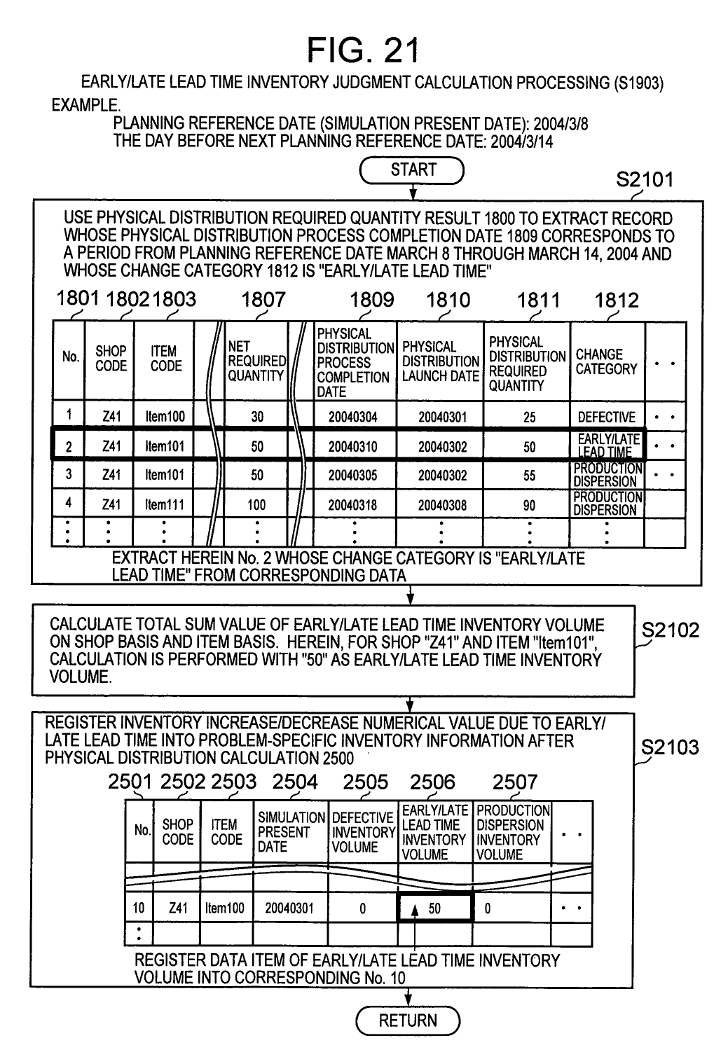

FIG. 21 is a flowchart of the early/late lead time judgment calculation processing (S1903). The inventory calculation section 114 extracts, from the physical distribution required quantity result 1800, a record whose physical distribution process completion date 1809 corresponds to a period (from Mar. 8, 2004 through Mar. 14, 2004) from the planning reference date through the day before the next planning reference date and whose change category 1812 is “early/late lead time” (S2101). In the example of FIG. 21, the record “No. 2” is extracted.

Subsequently, the inventory calculation section 114 uses the extracted records to calculate a total sum value of the inventory volume corresponding to the change category “early/late lead time” by shop and item (S2102). Herein, one data entry including the shop “Z41” and the item “Item101” is extracted and hence the total sum value is counted as “50”.

Subsequently, from the result obtained by the calculation of Step S2102, the inventory calculation section 114 registers the inventory increase/decrease numerical value due to the early/late lead time into the problem-specific inventory information after the physical distribution calculation 2500 (S2103), and returns to the flow of FIG. 19. Herein, “50” calculated in Step S2102 is registered as the “early/late lead time inventory volume 2506” of the record “No. 30”.

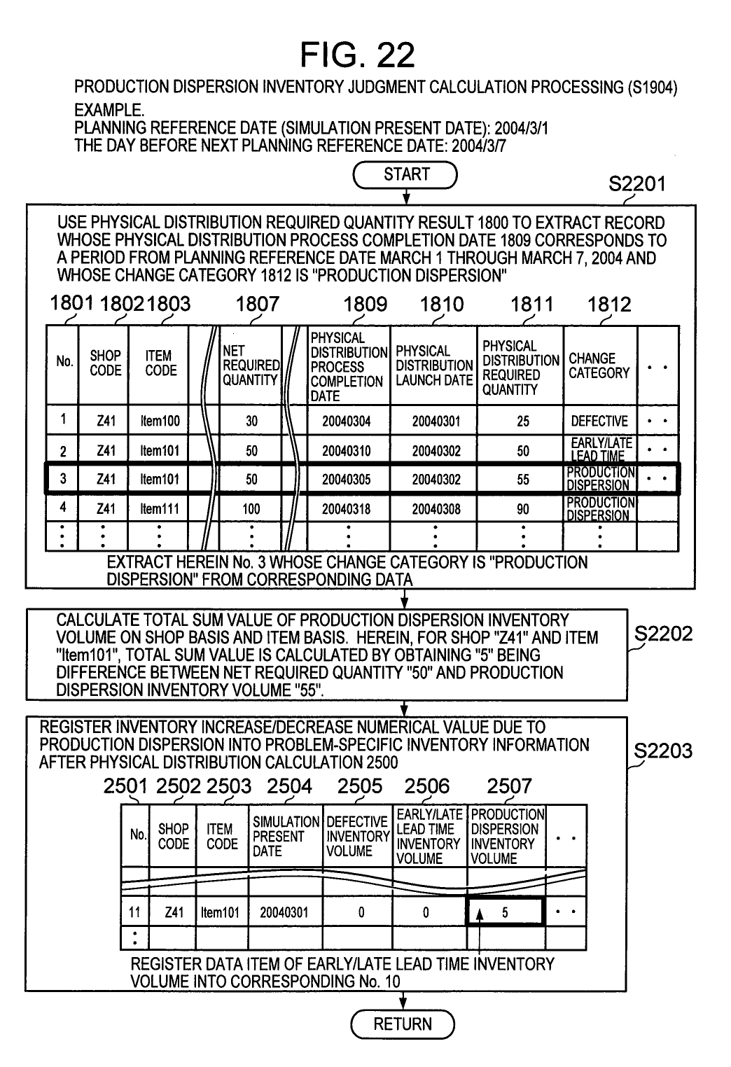

FIG. 22 is a flowchart of a production dispersion inventory judgment calculation processing (S1903).

The inventory calculation section 114 extracts, from the physical distribution required quantity result 1800, a record whose physical distribution process completion date 1809 corresponds to a period (from Mar. 1, 2004 through Mar. 7, 2004) from the planning reference date through the day before the next planning reference date and whose change category 1812 is “production dispersion” (S2201). In the example of FIG. 22, the record “No. 3” is extracted.

Subsequently, the inventory calculation section 114 calculates a total sum value of the inventory volume corresponding to the change category “production dispersion” on a shop basis and an item basis (S2202). In the example of FIG. 22, while the net required quantity is “50”, the distribution required quantity is “55” due to the production dispersion. Thus, the difference “5” is counted as the production dispersion inventory volume, and obtained as the total sum value. It should be noted that when the value of the production dispersion inventory volume becomes negative, a negative value is counted.

Subsequently, the inventory calculation section 114 registers the obtained inventory increase/decrease numerical value due to the production dispersion into the problem-specific inventory information after the physical distribution calculation 2500 (S2203), and returns to the flow of FIG. 19. For example, in this example, the total sum value “5” is registered as the “production dispersion inventory volume 2507” for the corresponding shop Z41, the item “Item101”, and the simulation present date “20040301”.

Thus, the inventory calculation section 114 brings the processing of Step S107 to an end.

<Processing of Calculating an Index and Outputting a Result (S108 of FIG. 3)>

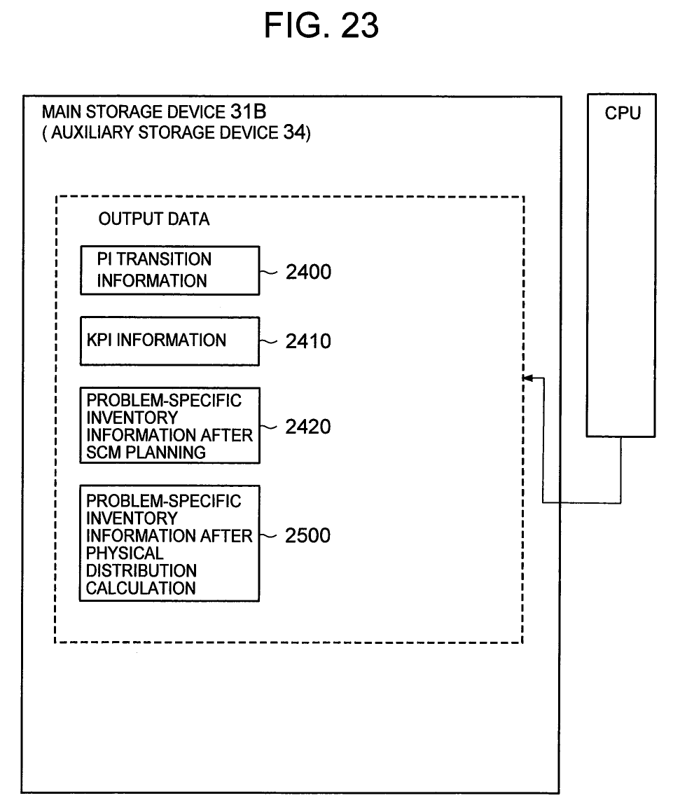

Next, description is made of the processing of calculating an index and outputting a result. FIG. 23 illustrates a file group output to the main storage device 31B or the auxiliary storage device 34. The output processing section 116 outputs files of a PI index (PI transition information) 2400, KPI information 2410, problem-specific inventory information after the SCM planning 2420, and the problem-specific inventory information after the physical distribution calculation 2500.

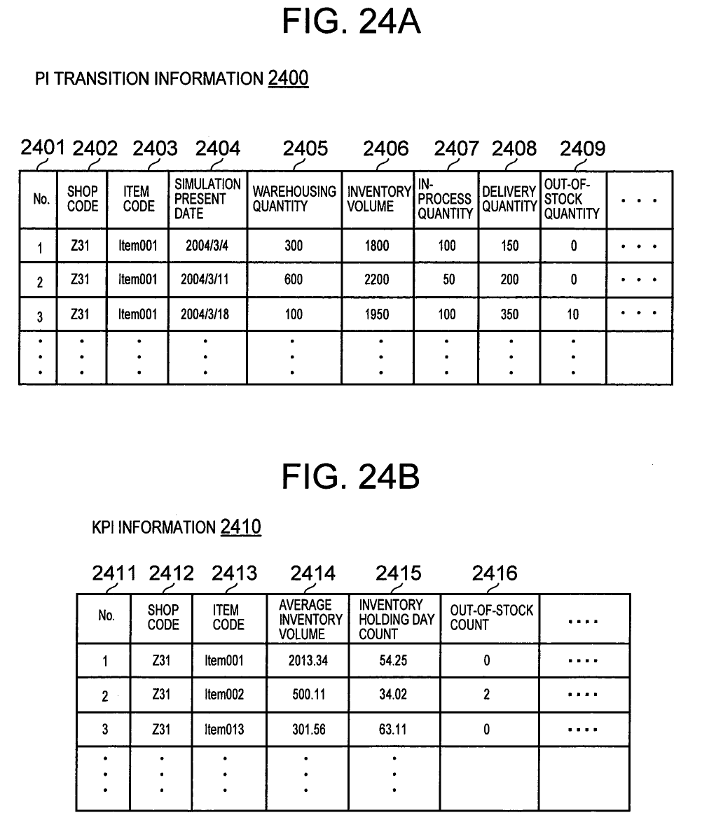

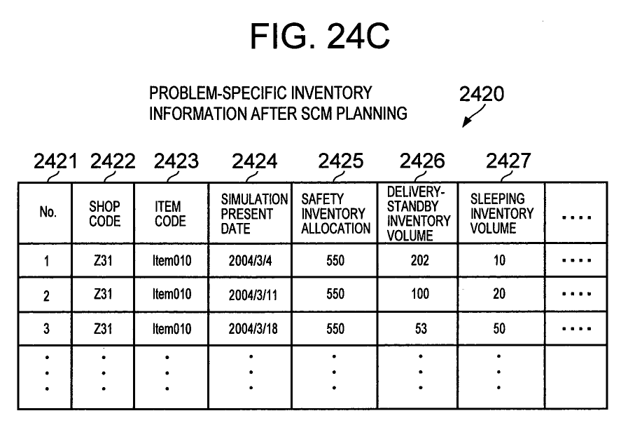

FIGS. 24A to 24C and 25 illustrate contents of those file.

As illustrated in FIG. 24A, the PI transition information 2400 is a group of indices indicating a change when time elapses by a simulation, and includes, in each record, indices such as a record number 2401, a shop code 2402, an item code 2403, a simulation present date 2404, a warehousing quantity 2405, an inventory volume 2406, an in-process quantity 2407, a delivery quantity 2408, and an out-of-stock quantity 2409. The contents are output as a file based on the physical distribution payout result 1830.

As illustrated in FIG. 24B, the KPI information 2410 is a group of indices indicating a main performance index (KPI) of the simulation result. The KPI information 2410 includes, in each record, information such as a record number 2411, a shop code 2412, an item code 2413, an average inventory volume 2414, an inventory holding day count 2415, and an out-of-stock count 2416.

The average inventory volume 2414 is a value obtained by dividing the total sum value on a shop basis and an item basis from the top of the simulation present date through the last of the simulation by the number of days from the first day through the last day. Further, the inventory holding day count 2415 is the number of days obtained by obtaining a delivery quantity per day during the simulation period and dividing the resultant into the average inventory volume.

The out-of-stock count 2416 is a value obtained by previously counting how many times the out-of-stock takes place in the PI transition information for each shop, item, and simulation present date and summing up the counts by the index calculation performed in Step S108.

As illustrated in FIG. 24C, the problem-specific inventory information after the SCM planning 2420 is obtained by outputting a file of contents calculated in the problem-specific inventory calculation processing after the SCM planning (S105). The problem-specific inventory information after the SCM planning 2420 includes, in each record, a group of indices such as a record number 2421, a shop code 2422, an item code 2423, a simulation present date 2424, a plan-allocated inventory volume (safety inventory allocation) 2425, a delivery-standby inventory volume 2426, and a sleeping inventory volume 2427.

As illustrated in FIG. 25, the problem-specific inventory information after the physical distribution calculation 2500 is obtained by outputting a file of contents calculated in the problem-specific inventory calculation processing after the physical distribution calculation (S107).

Next shown is a display image of a problem-specific inventory.

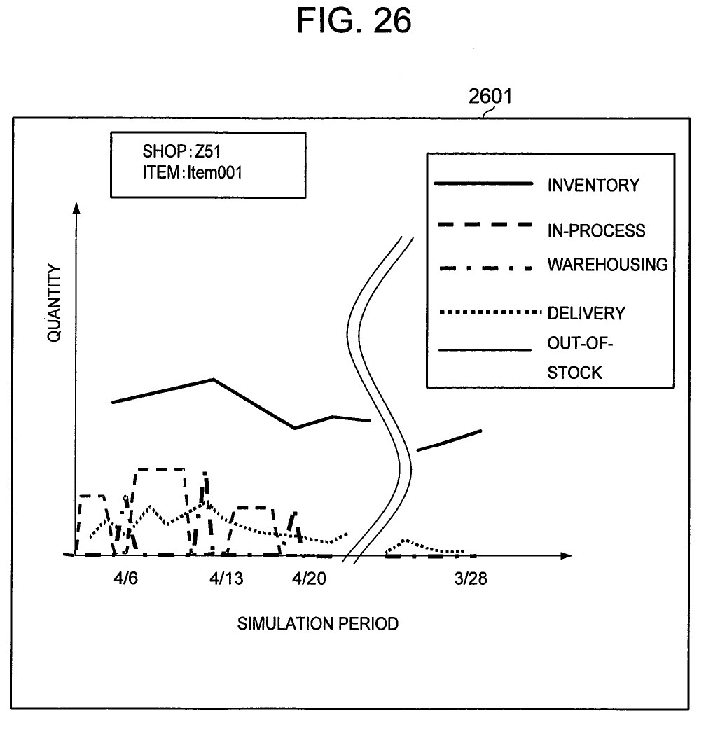

FIG. 26 is an example of graphic display 2601 for displaying the PI transition information 2400 onto a screen of the output device 33. In response to the operator's request, the output processing section 116 graphically displays the indices such as the inventory volume, in-process, warehousing, delivery, and out-of-stock for a specific shop and item by setting a quantity in the longitudinal axis and a simulation time in the horizontal axis.

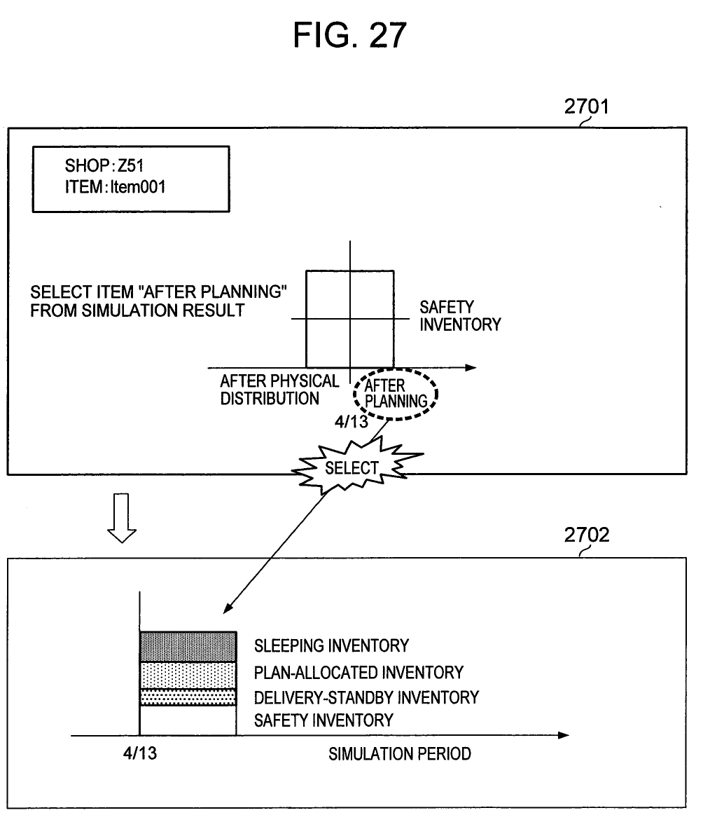

Further, as illustrated in FIG. 27, the output processing section 116 displays the inventory from the viewpoint of post-process of the supply chain planning. It should be noted that the output processing section 116 displays necessary data extracted from the problem-specific inventory information after the SCM planning 2420. FIG. 27 uses a bar graph to display the inventory for the specific simulation present date within the simulation period illustrated in FIG. 26.

To be specific, during the display of FIG. 26, the output processing section 116 receives a request to display inventory information for the specific simulation present date from the operator through the input device 32. Then, a record corresponding to the specified simulation present date is extracted from the problem-specific inventory information after the SCM planning 2420 and a problem-specific inventory display screen 2701 as illustrated in FIG. 27 is displayed.

In addition, in response to the request from the operator, the output processing section 116 uses the problem-specific inventory information after the SCM planning 2420 (plan-allocated inventory volume 2425, delivery-standby inventory volume 2426, and sleeping inventory volume 2427) and the safety inventory information 41G (safety inventory volume 634) to display an enlarged display screen 2702 containing the above-mentioned information.

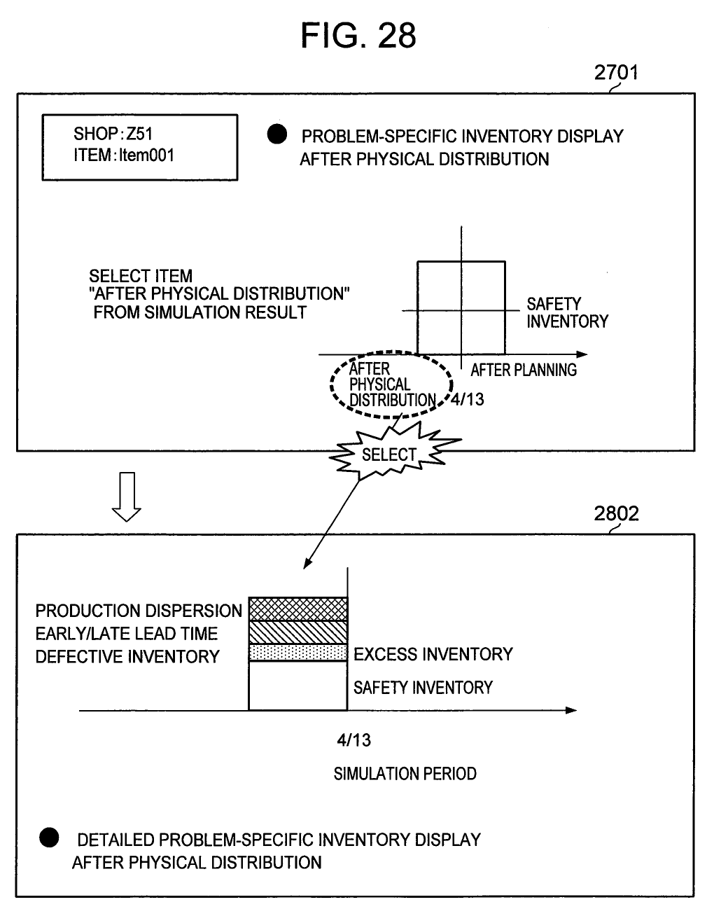

Further, in the same manner, as illustrated in FIG. 28, in response to the request from the operator, the problem-specific inventory information after the physical distribution calculation 2500 (defective inventory volume 2505, early/late lead time inventory volume 2506, and production dispersion inventory volume 2507) and the safety inventory information 41G (safety inventory volume 634) are used to display an enlarged display screen 2802 containing the above-mentioned information.

It should be noted that in FIGS. 27 and 28, bar graphs are used to display the problem-specific inventory, but a transition (line graph) depending on changes in the simulation time may be displayed for each entry. This makes it easier to indicate influences of elapsed time.

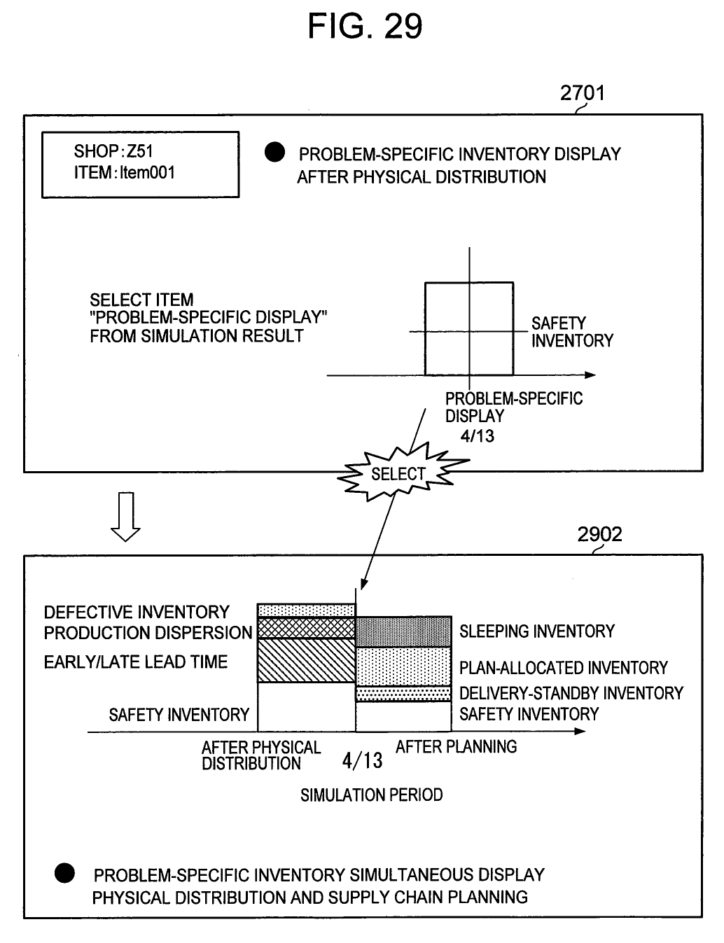

Further, in response to the request from the operator, as illustrated in FIG. 29, the output processing section 116 can also display the viewpoints of the physical distribution and the supply chain planning simultaneously (graphs of the enlarged display screens 2702 and 2802 of FIGS. 26 and 27). This makes it possible to centrally indicate according to which constraint has caused excess/insufficient inventory increase/decrease.

In FIG. 29, it is possible to notify clearly that, how the inventory that has increased/decreased by the physical distribution constraint is reserved for a plan in the supply chain planning, and also an influence due to a parameter change such as a change in the safety inventory.

The above description clarifies the embodiment of the supply chain evaluation system. The description of this embodiment is limited to a fundamental configuration, but for example, cost information for each shop, item, and simulation period may be provided to allow a cost evaluation. Further, the supply chain evaluation system is executed by an information processing terminal including a processing device, but may be realized in such a manner that an asset is not held by itself by performing a processing on another processing device via a network and receiving a trial calculation result of effects.

This system and processing program make it possible to perform not only the conventional evaluation of inventory reduction effects in comparison between plans but also an evaluation of whether or not the inventory is adequately controlled by chronologically checking changes of a structured inventory problem for each plan. In addition, grasping the inventory separately for each inventory problem helps discuss how to formulate a plan for measures such as which inventory is to be reduced, while the evaluation of only effective measures realizes prevention of repeated simulations and speedy and reliable implementation of the measures, which contributes to earlier recovery on investment and suppression of unnecessary investment costs.

What is claimed is:

1. A supply chain evaluation system being executed by a computer, in which, based on data obtained by modeling a supply chain corresponding to business activities for supplying goods to customers on a computer, a simulation is performed to evaluate reform effects when a supply chain model thus obtained is changed,
wherein the computer system is configured to:
perform a processing of alternately repeating a supply chain planning calculation and a physical distribution calculation;
perform a processing of calculating an inventory volume after each calculation processing for each inventory occurrence factor; and
perform a processing of outputting the inventory volume for each inventory occurrence factor.

2. A supply chain evaluation system according to claim 1, wherein the computer system is further configured to:
after the supply chain planning calculation,
calculate the inventory volume for each problem with supply chain planning including at least one of: a safety inventory; a delivery-standby inventory; a plan-allocated inventory; and a sleeping inventory, as the inventory occurrence factor;
display an inventory transition of a simulation result; and
graphically display the inventory volume for each problem with the supply chain planning in response to a request from an operator.

3. A supply chain evaluation system according to claim 1, wherein the computer system is further configured to:
after receiving a supply chain planning calculation result and executing the physical distribution calculation,
calculate the inventory volume for each problem with a physical distribution constraint including at least one of: a safety inventory; a defective inventory; an early/late lead time inventory; and a production dispersion inventory, as the inventory occurrence factor;
display an inventory transition of a simulation result; and
graphically display the inventory volume for each problem with the physical distribution constraint in response to a request from an operator.

4. A supply chain evaluation system according to claim 1, wherein the computer system is further configured to:
after the supply chain planning calculation,
calculate the inventory volume for each problem with supply chain planning including at least one of: a safety inventory; a delivery-standby inventory; a plan-allocated inventory; and a sleeping inventory;
after executing the physical distribution calculation,
calculate the inventory volume for each problem with a physical distribution constraint including at least one of: a safety inventory; a defective inventory; an early/late lead time inventory; and a production dispersion inventory;
display an inventory transition of a simulation result; and
switch between graphic display of the inventory volume for each problem with the supply chain planning and graphic display of the inventory volume for each problem with the physical distribution constraint in response to a request from an operator.

5. A supply chain evaluation method being executed by a computer system, in which, based on data obtained by modeling a supply chain corresponding to business activities for supplying goods to customers on a computer, performs a simulation to evaluate reform effects when a supply chain model thus obtained is changed, the supply chain evaluation method comprising:
performing, by the computer system, a processing of alternately repeating a supply chain planning calculation and a physical distribution calculation;
performing, by the computer system, a processing of calculating an inventory volume after each calculation processing for each inventory occurrence factor; and
performing, by the computer system, a processing of outputting the inventory volume for each inventory occurrence factor.

6. A computer program which causes a computer to function as a supply chain evaluation system, in which a simulation is performed based on data obtained by modeling a supply chain corresponding to business activities for supplying goods to customers on the computer, to evaluate reform effects when a supply chain model thus obtained is changed,
wherein the computer program causes the computer to:
perform a processing of alternately repeating a supply chain planning calculation and a physical distribution calculation;
perform a processing of calculating an inventory volume after each calculation processing for each inventory occurrence factor; and
perform a processing of outputting the inventory volume for each inventory occurrence factor.
